(19) United States
(12) Patent Application Publication
(10) Pub. No.: US 2024/0382953 A1
(43) Pub. Date: Nov. 21, 2024

(54) DEVICES AND METHODS FOR MANIPULATION AND SENSING OF PARTICLES IN A MICROFLUIDIC SYSTEM

(71) Applicant: TDK Corporation, Tokyo (JP)

(72) Inventors: Manish Giri, San Jose, CA (US); Rakesh Sethi, San Jose, CA (US); Vadim Piskun, San Jose, CA (US)

(73) Assignee: TDK Corporation, Tokyo (JP)

(21) Appl. No.: 18/655,717

(22) Filed: May 6, 2024

Related U.S. Application Data
(60) Provisional application No. 63/467,903, filed on May 19, 2023.

(51) Int. Cl. B01L 3/00

(52) U.S. Cl. CPC B01L 3/502715; B01L 3/502769; B01L 2200/027

(57) ABSTRACT

A microfluidic device and a method for manipulating, and sensing at least one property of, cells or particles in a microfluidic channel are disclosed. The microfluidic device includes a microfluidic channel arranged on a substrate, a sensing zone arranged along a portion of the microfluidic channel, and a set of piezoelectric actuators arranged in proximity to the sensing zone. The sensing zone is configured to measure one or more properties of a cell or a particle in a fluid sample in the microfluidic channel. The set of piezoelectric actuators is configured to cause manipulation of the particle while the particle is in the sensing zone.

### PRIORITY AND RELATED APPLICATIONS

This application claims priority to U.S. Provisional Patent Ser. No. 63/467,903, filed May 19, 2023, entitled “Microfluidic chip for 3D scanning of single cells using piezoelectric actuators in a sensing zone,” which is incorporated by reference herein in its entirety.

### TECHNICAL FIELD

This application relates generally microfluidic devices, including but not limited to, manipulation and sensing of particles in a microfluidic flow channel.

### BACKGROUND

Samples (e.g., cells and other particles) flowing in a microfluidic device may be deflected by acoustic waves. When these samples are travelling in a laminar flow, an acoustic wave applied perpendicular to the direction of the laminar flow alters the trajectory of the samples such that they may be sorted into different flow streams. Conventionally, the sensing of samples is performed optically or via a fluorescent marker, but these methods only allow a limited number of qualities of the samples to be measured and may require that the samples be altered and/or damaged. Conventional electrical sensing of samples also has limitations. Because each sample is moving in the microfluidic device, only a fixed configuration of each sample can be measured at a time. In this way, valuable information about the sample can be missed and/or each sample may need to be processed through the microfluidic device multiple times in order to capture all of the desired information.

### SUMMARY

As described above, comprehensive sensing of samples is a challenging problem in microfluidic devices. In some systems, samples can be sensed using electrical fields applied by electrodes. However, as mentioned above, conventional microfluidic devices only allow a fixed configuration of the sample to be measured at a time, and valuable information about the sample can therefore be missed. Devices and methods for manipulating and sensing particle samples in microfluidic devices and systems are described herein. Such devices and methods address challenges associated with conventional devices and methods for sensing cell samples in microfluidic devices or systems.

For example, a sample sensing system (e.g., for cells, bacteria, and/or viruses) with integrated sets of piezoelectric actuators (e.g., that form a laminar flow in the microfluidic device), and electrodes is described herein. For example, the sets of piezoelectric actuators may manipulate particles of a fluidic sample by disrupting the laminar flow via acoustic waves. While the sets of piezoelectric actuators manipulate particles, the electrodes may sense one or more properties of the particles from different angles and orientations. In this way, a three-dimensional (3D) scan of the particles may be obtained and analyzed.

In one aspect, a microfluidic device includes: (i) a microfluidic channel arranged on a substrate, (ii) a sensing zone arranged along a portion of the microfluidic channel, and (iii) a set of piezoelectric actuators arranged in proximity to the sensing zone. The sensing zone is configured to measure one or more properties (e.g., an impedance) of a particle (e.g., a cell) in a fluid sample in the microfluidic channel. The set of piezoelectric actuators is configured to cause manipulation of the particle (e.g., levitating, rotating, localizing, and/or deflecting the particles in three dimensions) while the particle is in the sensing zone. For example, the set of piezoelectric actuators may be configured to cause each particle to rotate at least 90 degrees while in the sensing zone such that a 3D scan of the particle is performed.

In another aspect, some embodiments include a method performed at a microfluidic device. The method comprises: (i) providing a fluidic sample comprising a plurality of particles through an inlet to a microfluidic channel of the microfluidic device, (ii) sensing one or more properties of one or more particles of the fluidic sample while the one or more particles are in a sensing zone of the microfluidic channel, (iii) selectively manipulating, using a set of piezoelectric actuators, the one or more particles of the fluidic sample while the one or more particles are in the sensing zone, and (iv), after the one or more particles leave the sensing zone, ejecting the one or more particles from an outlet of the microfluidic channel. For example, selectively manipulating the one or more particles of the fluidic sample while the one or more particles are in the sensing zone allows for a 3D scan of the particle(s) to be performed.

Thus, the disclosed devices and methods relate to techniques for manipulating and sensing particle samples which are implemented within or as part of a microfluidic device using sets piezoelectric actuators. Such techniques provide reliable localization and analysis of single-particle samples. The disclosed devices and methods may replace, or complement, conventional devices and methods.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1A shows a plan view of an example microfluidic device in accordance with some embodiments.

FIG. 1B shows a cross-section view of the microfluidic device of FIG. 1A in accordance with some embodiments.

FIG. 1C shows a cross-sectional view of an input region of the microfluidic device of FIG. 1A in accordance with some embodiments.

FIG. 1D shows a cross-sectional view of a regulation region of the microfluidic device of FIG. 1A in accordance with some embodiments.

FIG. 1E shows a cross-section view of an output region of the microfluidic device of FIG. 1A in accordance with some embodiments.

FIG. 1F shows a second cross-section view the regulation region of the microfluidic device of FIG. 1A in accordance with some embodiments.

FIGS. 2A-2G shows alternative embodiments for a pattern of a first set of piezoelectric actuators in the input region of a microfluidic device in accordance with some embodiments.

FIG. 3A shows a plan view of an example microfluidic device in accordance with some embodiments.

FIG. 3B shows a plan view of another example microfluidic device in accordance with some embodiments.

FIG. 4 shows an example of acoustic waves colliding at a particle of a sample fluid in accordance with some embodiments.

FIGS. 5A-5F show example patterns for arranging and piezoelectric actuators for sensing one or more properties of a particle in accordance with some embodiments.

FIG. 6 is a block diagram illustrating an example system for a microfluidic device in accordance with some embodiments.

FIG. 7 is a flow diagram illustrating an example method of dissociating and manipulating cells or particles in a microfluidic channel in accordance with some embodiments.

FIG. 8 is a flow diagram illustrating an example method of manipulating and sensing cells or particles in a microfluidic channel in accordance with some embodiments.

In accordance with common practice, the various features illustrated in the drawings are not necessarily drawn to scale, and like reference numerals can be used to denote like features throughout the specification and figures.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

The microfluidic devices described herein allow for electrical and/or optical sensing of one or more cells (or other particles such as bacteria, viruses, elements, compounds, and the like). The microfluidic aspect of the devices allows for precise dissociating and manipulating particles in a microfluidic channel (e.g., using sets of piezoelectric actuators) and accurate/precise measurements of particle properties. Additionally, the microfluidic device having an outlet port (e.g., a nozzle) with corresponding piezoelectric actuators allows for direct ejection (e.g., jetting) of cells (e.g., after they have been processed) and regulation of the flow rate through the microfluidic device.

The piezoelectric membranes described herein can improve processing (e.g., case of processing and reproducibility). For example, the piezoelectric membrane can be placed between a silicon on insulator (SOI) handler layer and a glass top layer and encased in a passivation material (e.g., a dielectric material) such that the membrane is not exposed to the samples, fluids, and cleaning solutions used with the microfluidic device. As an example, the membrane can be formed by selectively etching the SOI. This can also allow for easier wafer handling. The devices described herein can also improve packaging flexibility and/or improve robustness (improved yield) by mechanically protecting the piezoelectric actuators and membranes.

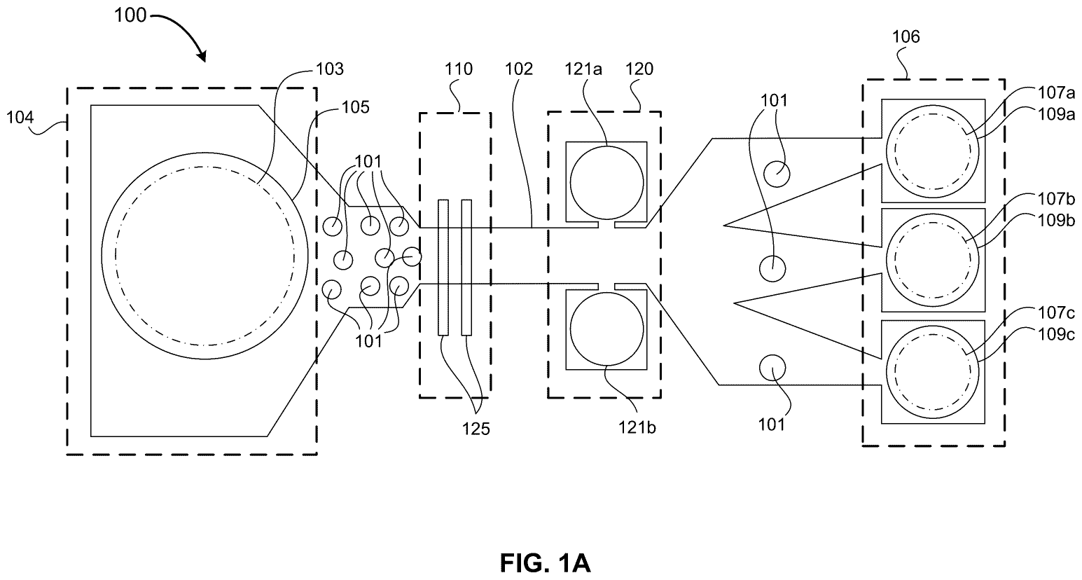

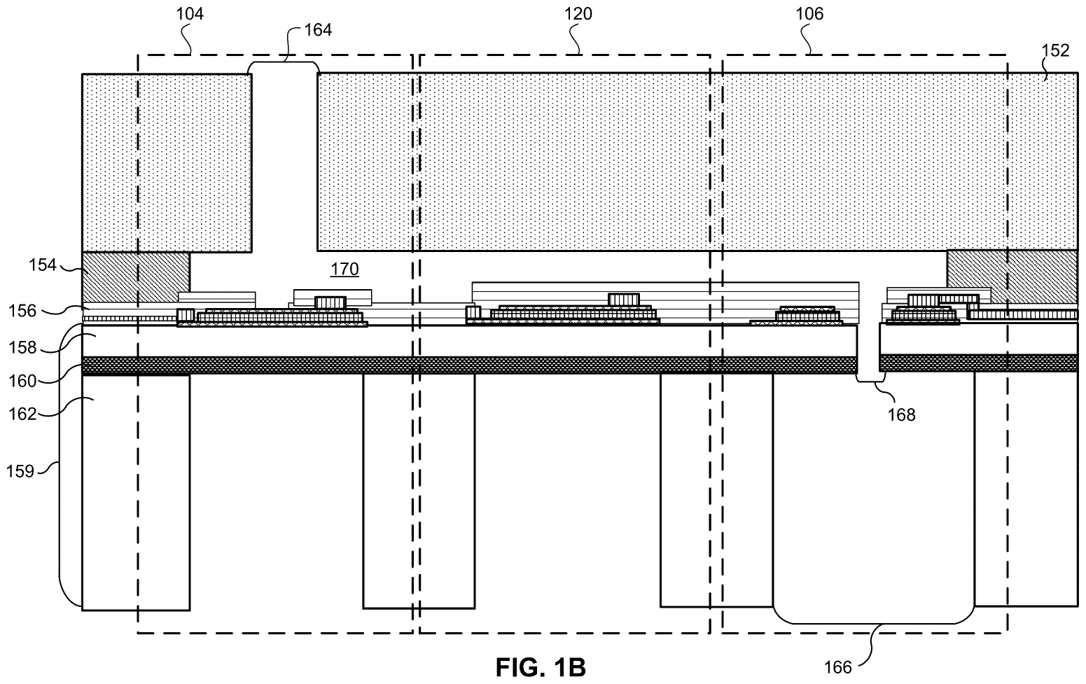

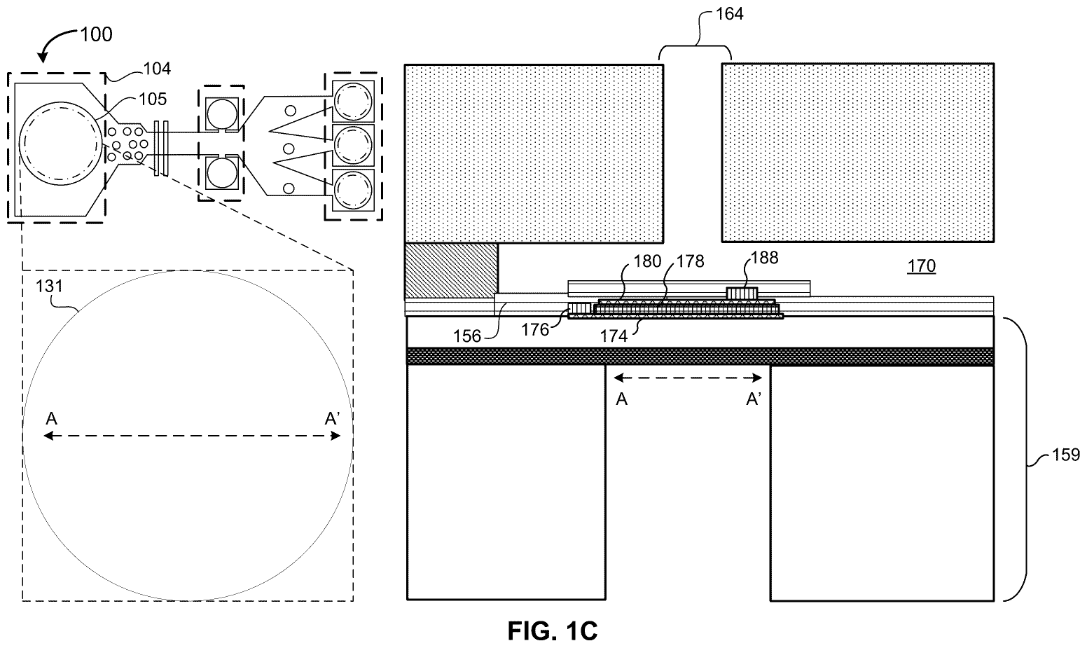

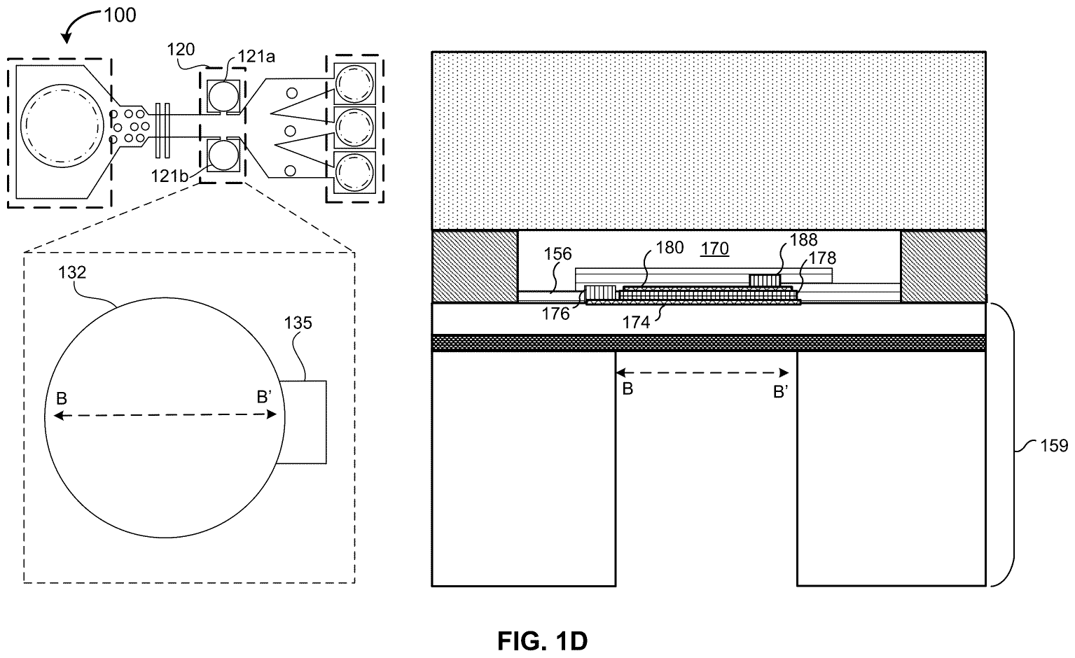

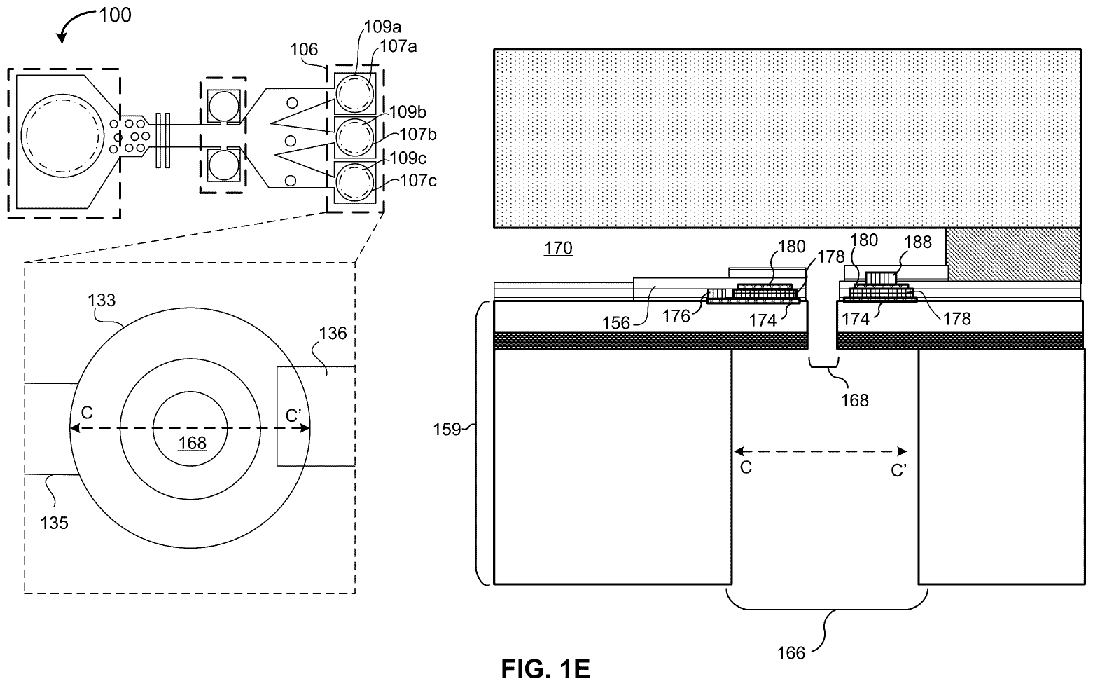

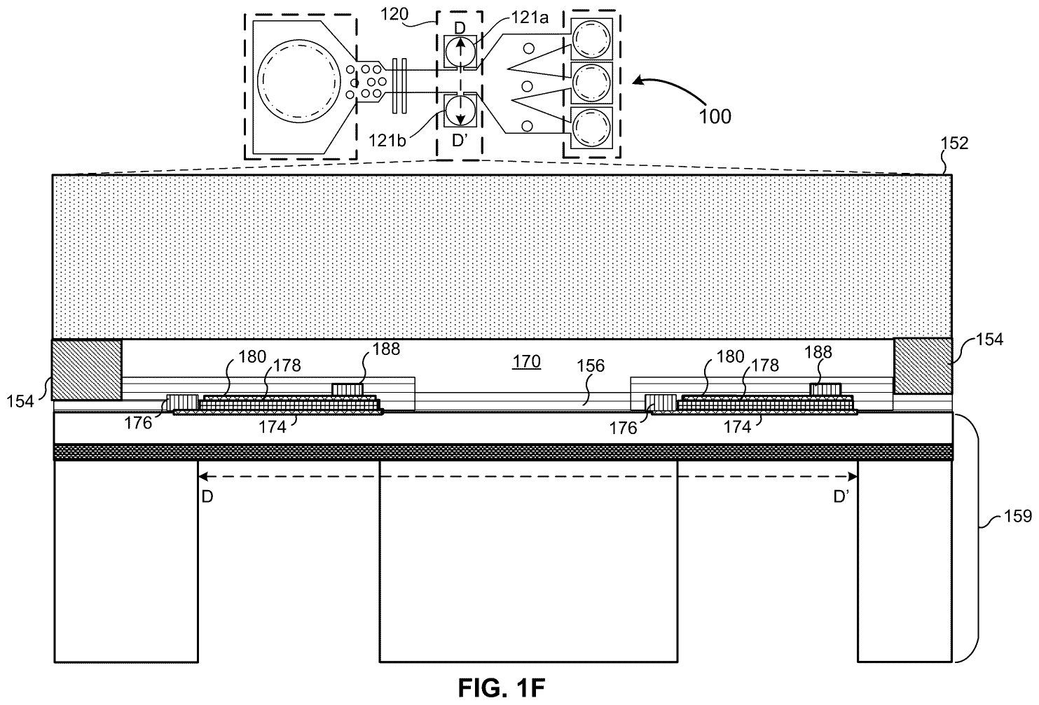

FIG. 1A shows a plan view of a microfluidic device 100 in accordance with some embodiments. The microfluidic device 100 includes a fluidic channel 102 (e.g., a microfluidic channel) formed on a substrate. In some embodiments, the fluidic channel 102 is formed by coupling a first substrate with an indentation, recess, or notch with a second substrate so that the fluidic channel 102 is defined between the first substrate and the second substrate. The fluidic channel 102 has an inlet 103 and a plurality of outlets 107a-107c (e.g., three outlets as illustrated in FIG. 1A). The locations of the inlet 103 and the plurality of outlets 107a-107c shown with respect to the fluidic channel 102 in FIG. 1A are examples. The inlet 103 and the plurality of outlets 107a-107c may be defined at other locations along the length dimension of the fluidic channel 102 or the microfluidic device 100.

In some embodiments, the microfluidic device 100 comprises more or less outlets than shown in FIG. 1A (e.g., 1, 2, 4, 5, or 6 outlets). In some embodiments, a length of the fluidic channel 102 (e.g., measured from the inlet 103 to the plurality of outlets 107a-107c) is in the range of 1 millimeter (mm) to 50 mm (e.g., 15 mm). In some embodiments, a width of the microfluidic device 100 is in the range of 0.2 mm to 50 mm (e.g., 0.7 mm). In some embodiments, a width of the fluidic channel 102 is configured based on a size of a particle to be analyzed. For example, for cellular measurements, the width of the fluidic channel 102 may be configured in accordance with the size of a cell such that only a single cell is detected at a time (e.g., a width of the fluidic channel 102 at a sensing region 110). In some embodiments, the fluidic channel 102 includes one or more portions that have different respective widths. For example, the fluidic channel 102 may include portions having (protruding) shapes such that widths of the portions are greater than the width of the fluidic channel 102 at the sensing region 110 (e.g., a width of the fluidic channel 102 at a regulation region 120). Similarly, the fluidic channel 102 may include one or more portions with widths narrower than the width of the fluidic channel 102 at the sensing region 110. In some embodiments, a wider fluidic channel 102 results in a slower velocity of particles flowing in the corresponding portion of the fluidic channel 102 (e.g., when the fluidic channel 102 has a uniform height). As such, for example, a wider portion may be used to reduce the velocity of the particles (e.g., immobilize the particles), which can allow for more time for analyzing the particles.

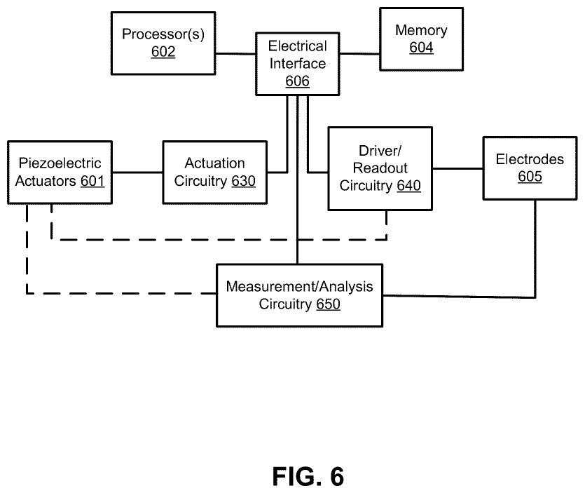

The device 100 also includes an input region 104 (also sometimes referred to as an inlet region) for receiving a sample fluid with particles (e.g., cells) as an input to the microfluidic device 100 and providing the sample fluid from the inlet port to the fluidic channel 102 via the inlet 103. In accordance with some embodiments, microfluidic device 100 includes a plurality of pillars 101 adjacent to (or within) the input region 104. The pillars 101 may be shaped and arranged to disrupt (e.g., separate) the particles in the sample fluid. The shape and size of the input region 104 in FIG. 1A is a mere example and other sizes and shapes may be used. The microfluidic device 100 includes a set of piezoelectric actuators 105 at the input region 104 (e.g., around the inlet 103). In some embodiments, the set of piezoelectric actuators 105 is a single piezoelectric actuator (e.g., as illustrated in FIG. 1A). In some embodiments, the set of piezoelectric actuators 105 is located adjacent to the inlet 103 and is configured to induce a laminar flow from the inlet 103 toward the plurality of outlets 107a-107c. In some embodiments, the set of piezoelectric actuators 105 is configured to de-clump and/or de-clog the sample fluid at (and/or near) the inlet 103. In some embodiments, the set of piezoelectric actuators 105 is configured to generate inertial and acoustic turbulence in asymmetric channels to cause chaotic advection and drive localized non-linear behavior in a laminar flow field. In some embodiments, upon application of an electrical signal from actuation circuitry (e.g., the actuation circuitry 630 described with respect to FIG. 6), the set of piezoelectric actuators 105 generates oscillations that create displacement as well as acoustic waves which causes mixing and dissociation of the sample fluid and controls localized inertial movement of the particles to induce a laminar flow in the fluidic channel 102. In some embodiments, the set of piezoelectric actuators 105 is configured to adjust particle mixing, particle dissociation, particle agglomeration, particle coagulation, particle clogging in the fluid sample (e.g., to dissociate any clogged particles and/or prevent clogging of the input region 104 and/or a sensing region 110). In some embodiments, the set of piezoelectric actuators 105 is configured to adjust particle and/or fluidic viscosity and/or density of the fluid sample. In some embodiments, the set of piezoelectric actuators 105 is configured to control and/or prevent bubble formation in the fluid sample.

The microfluidic device 100 further includes an output region 106 for collecting at least a portion of the sample fluid from the fluidic channel 102 and ejecting or delivering the sample fluid portion via the plurality of outlets (e.g., nozzles) 107a-107c for disposal or further processing or analysis. In some embodiments, the output region 106 includes a plurality of output subregions, each subregion including one of the plurality of outlets 107a-107c. The shape and size of the output region 106 and the output subregions in FIG. 1A are mere examples and other shapes and sizes may be used. The output region 106 includes a set of piezoelectric actuators 109a-109c, located adjacent to each of the plurality of outlets 107a-107c for ejecting a portion of the fluid in the fluidic channel 102. In some embodiments, each output subregion includes a subset of the set of piezoelectric actuators 109a-109c, each subset adjacent to a respective outlet of the plurality of outlets 107a-107c. As such, different portions of the sample fluid may be collected at, and ejected from, a corresponding output subregion. In some embodiments, the microfluidic device 100 is configured such that each output subregion, and each outlet of the plurality of outlets 107a-107c, is associated with a different type of particle and/or a different quality of the particles in the fluid sample. For example, the regulation region 120, described below, may be configured to cause different types of particles in the fluid sample to flow to different outlets of the plurality of outlets 107a-107c.

The microfluidic device 100 further includes the regulation region 120 for regulating the flow of the sample fluid and manipulating the particles (e.g., levitating, rotating, localizing, and/or deflecting a cell) in the sample fluid. The shape and size of the regulation region 120 in FIG. 1A is a mere example. The regulation region 120 includes a set of piezoelectric actuators 121a-121b. In some embodiments, the set of piezoelectric actuators 121a-121b is located between the inlet 103 and the plurality of outlets 107a-107c (e.g., the inlet 103 may be located in an upstream region of the fluidic channel 102, the plurality of outlets 107a-107c may be located in a downstream region of the fluidic channel 102, and the set of piezoelectric actuators may be located in a midstream region of the fluidic channel 102). In some embodiments, the set of piezoelectric actuators 121a-121b is located between the sensing region 110 and the output region 106. In some embodiments, the set of piezoelectric actuators 121a-121b is located within the sensing region 110 (e.g., and configured to manipulate orientation, movement, and/or deflection of particles in the sensing region). In some embodiments, the set of piezoelectric actuators 121a-121b include actuators arranged on opposite sides of the fluidic channel 102 (e.g., the two actuators illustrated in FIG. 1A). In some embodiments, the set of piezoelectric actuators 121a-121b are configured to deflect the particles in the fluid sample to a specified output subregion of the output region 106 based on one or more properties of the particle in the fluid sample (e.g., each output subregion corresponding to a particular cell or a type of cell). The manipulation of the particles of the sample fluid may be achieved, for example, by the oscillations and displacement caused by activation of the set of piezoelectric actuators 121a-121b. For example, the oscillations and displacement provided by the set of piezoelectric actuators 121a-121b may control movement, position, rotation and/or acceleration of the particles in the fluidic channel 102. In some embodiments, the set of piezoelectric actuators 121a-121b are configured to vibrate in a direction that is perpendicular to the flow of the sample fluid in the fluidic channel 102. For example, two actuators placed on either side of the fluidic channel 102 operate in tandem to either deflect the particles downstream into one of the output subregions and/or regulate the location of the particles (e.g., sorting may be performed based on label-free phenotypic analysis of cells and various cell population types can be isolated and/or enriched). The manipulation of the particles may be based on instructions from the sensing region 110 and/or the actuation circuitry 630. In some embodiments, the set of piezoelectric actuators include more than two piezoelectric actuators (e.g., two pairs, three pairs, or four pairs of piezoelectric actuators). In some embodiments, piezoelectric actuators of the set of piezoelectric actuators are offset from one another (e.g., the piezoelectric actuator 121a is positioned upstream from the piezoelectric actuator 121b, or vice versa). In some embodiments, piezoelectric actuators of the set of piezoelectric actuators have differing sizes and/or shapes.

In some embodiments, each of the three sets of piezoelectric actuators (the set of piezoelectric actuators 105, the set of piezoelectric actuators 121a-121c, and the set of piezoelectric actuators 109a-109c) includes one or more piezoelectric actuators (e.g., a piezo micro-electro-mechanical system (MEMS) actuator). In some embodiments, each of the three sets of piezoelectric actuators includes two or more piezoelectric actuators. In some embodiments, the set of piezoelectric actuators 105 comprise one or more actuators having a first size, the set of piezoelectric actuators 121a-121b comprise one or more actuators having a second size, different than the first size, and the set of piezoelectric actuators 109a-109c comprise one or more actuators having a third size, different from the first size and the second size (e.g., the first size is three times the second size and two times the third size). In some embodiments, each of the three sets of piezoelectric actuators have a thickness in a range of 0.1 micron (μm) to 5 μm. In some embodiments, each of the three sets of piezoelectric actuators is arranged on a membrane (e.g., the membrane is composed of a substrate with a thickness in a range of 1 μm to 5 μm).

In some embodiments, the microfluidic device 100 includes actuation circuitry electrically coupled to each of the three sets of piezoelectric actuators (e.g., the actuation circuitry 630 described with respect to FIG. 6). In some embodiments, each of the three sets of piezoelectric actuators is configured to vibrate at a configurable frequency (e.g., in a range of 1 kilohertz (kHz) to 100 gigahertz (GHz)). In some embodiments, operating in the frequency range comprises vibrating in the frequency range. In some embodiments, at least a subset of the three sets piezoelectric actuators described herein is configured to use an operating frequency within the frequency range that is based on a type of particles in the sample fluid and/or an intended operation (e.g., dissociation, levitation, rotation, and/or mixing). As an example, a megahertz (MHz) subrange may be used to levitate particles (e.g., cells), a kHz and/or MHz subrange may be used to rotate particles, and a kHz range may be used to sort particles. As another example, the set of piezoelectric actuators may operate in a kHz and/or MHz range to perform ultrasonication of the sample, where the selected frequency may depend on the desired function (e.g., disrupt clumps, disrupt clogs and/or push/stimulate fluid flow) and the types of particles in the sample.

In some situations, the piezoelectric actuators disclosed herein operate at low power and their operating mode is adjustable based on the performance function desired. In some embodiments, each of the three sets of piezoelectric actuators is configured to have an operating voltage in the range of 0.1 volt (V) to 100 V (e.g., a range of 0.1 V to 30 V) based on a type of actuator and/or a type of sample. For example, a lead zirconate titanate (PZT) actuator may have an operating voltage up to 30 V whereas a polymer actuator may have an operating voltage in the range up to 50 V. In some embodiments, each of the three sets of piezoelectric actuators are configured to have a deflection in a range of 5 nanometers (nm) to 50 μm (e.g., a range 100 nm to 10 μm) based on a type of actuator and/or a type of sample. In some embodiments, upon application of an electrical signal from the actuation circuitry, each of the three sets of piezoelectric actuators (either individually or synchronously) generate oscillations that create displacement as well as acoustic waves, which control localized inertial movement of the particles in the fluidic channel 102 in the three-dimensional x, y, and z planes with sub-μm level control. In some embodiments, each of the three sets of piezoelectric actuators induce a laminar flow from the inlet 103 toward the plurality of outlets 107a-107c. In some configurations, the sample fluid flows through the fluidic channel 102 at a rate between 1 μL/min and 1 mL/min.

In some embodiments, the microfluidic device 100 further includes the sensing region 110 for sensing one or more properties of the particles in fluid sample. In some embodiments, the sensing region 110 overlaps with (e.g., is the same as) the regulation region 120. The sensing region 110 comprises a set of electrodes 125 and/or other sensing elements for sensing the one or more properties. In some embodiments, an echo response of the set of piezoelectric actuators 105 in the input region 104 and/or the set of piezoelectric actuators 121a-121b in the regulation region 120 is sensed to determine properties of the sample and/or the microfluidic channel (e.g., an actuator's echo response will change if a foreign object is on the actuator). The position of the sensing region 110 in FIG. 1A is a mere example. In various embodiments, the sensing region 110 may be located closer or further from the input region 104. In some embodiments, the sensing region 110 has a larger (or smaller) size (e.g., length) than is illustrated in FIG. 1A. In some embodiments, the sensing region 110 includes at least one filter (e.g., a filter pillar array). The position of the set of electrodes 125 and the sensing region 110 may be varied along the length of the fluidic channel 102. For example, it may be beneficial to have equal distances between each electrode of the set of electrodes to acquire accurate measurements. In some embodiments, the set of electrodes detect electrical signals of particles (e.g., cells) flowing through the fluidic channel 102 adjacent to the set of electrodes. In some embodiments, the microfluidic device 100 includes readout circuitry (e.g., the driver/readout circuitry 640 described with respect to FIG. 6) electrically coupled with the set of electrodes. In some embodiments, the readout circuitry receives electrical signals from the set of electrodes and relays the electrical signals (with or without processing, such as filtering) to one or more processors of, or operationally connected with, the microfluidic device 100.

In some embodiments, the set of electrodes charge particles flowing through the fluidic channel 102 by applying an electrical field to the sample fluid to charge the particles such that the particles may be manipulated by another electrical field. In some embodiments, the distance between a pair of the electrodes is configured such that only a single particle is charged and/or manipulated at a time. In some embodiments, the microfluidic device 100 includes driver circuitry (e.g., the driver circuitry 640 described with respect to FIG. 6) electrically coupled to the set of electrodes. In some embodiments, the driver circuitry is configured to produce electrical signals in the MHz and GHz frequency domains. In some embodiments, the frequency of the electrical signals provided to the electrodes depends on a type or types of the particles to be analyzed using the microfluidic device 100. In some embodiments, the driver circuitry is configured to produce electrical signals with a voltage in the range of 1 V to 100 V. In some embodiments, the driver circuitry is configured to produce electrical signals with a pulse in a range from 1 μs to 20 μs. In some embodiments, the pulse has a rise and/or fall time in a range from 0.5 μs to 10 μs. In some embodiments, the pulse is a sawtooth pulse, a square pulse, or a sinusoidal pulse.

In some embodiments, each particle may pass the vicinity of one or more pairs of electrodes for a period between 0.01 milliseconds (ms) and 100 ms (e.g., based on the fluidic flow rate). In some embodiments, each particle may pass the vicinity of one or more second pairs of electrodes for a period between 0.1 ms and 100 ms. In some embodiments, a separation distance between a pair of electrodes as well as a distance between the first electrodes and the second electrodes are configured based on a type or types of the particles to be analyzed using the device 100. In some embodiments, a particle processing rate in the microfluidic device 100 is between from 100 particles per minute and 1 million particles per minute.

In some embodiments, the set of electrodes is located on a same substrate as one another and/or the piezoelectric components. In some embodiments, a pair of electrodes is located on different substrates (e.g., one electrode of a pair of electrodes is located on a bottom substrate and another electrode of the pair of electrodes is located on a top substrate). In some embodiments, the electrodes have a thickness in the range of 0.01 μm to 2 μm. In some embodiments, the electrodes are composed of gold (Au), platinum (Pt), or other type of metal or metal alloy. In some embodiments, the additional set of electrodes are shielded from each of the three sets of piezoelectric actuators. For example, the electrodes are on a first board/chip and each of the sets of piezoelectric actuators are on a separate board/chip. In some embodiments, the operation of the electrodes is based on the operation of each of the sets of piezoelectric actuators (e.g., the electrode operation is timed to reduce/minimize interference from operation of each of the sets of piezoelectric actuators).

FIG. 1B shows a cross-section view of the microfluidic device 100 in accordance with some embodiments. As shown in FIG. 1B, the microfluidic device 100 includes an optical layer 152 (e.g., composed of a transparent or translucent material such as glass) with an inlet channel 164 (e.g., the inlet 103 shown in FIG. 1A). The optical layer 152 is coupled to a substrate 159 via a bonding layer 154 (e.g., composed of a polymer). The bonding layer 154 defines a fluidic channel 170 (e.g., the fluidic channel 102 shown in FIG. 1A). In some embodiments, the fluidic channel 170 is a microfluidic channel. In accordance with some embodiments, an outlet channel 166 is defined in the substrate 159 (e.g., etched in the handler layer 162). In some embodiments, the three sets of piezoelectric actuators described in reference to FIG. 1A are arranged over portions of the substrate from which the silicon base layer have been removed (e.g., to form a membrane below the actuators) (e.g., as illustrated in FIGS. 1B-1F). In the example of FIG. 1B, the substrate 159 includes a handler layer 162 (e.g., composed of silicon), a buried oxide (BOX) layer 160 (e.g., composed of SiO2), and a device layer 158. In accordance with some embodiments, an outlet 168 (e.g., one outlet of the plurality of outlets 107a-107c shown in FIG. 1A) is defined in the substrate 159 (e.g., through a BOX layer 160 and the device layer 158). A passivation layer 156 (e.g., an encapsulation layer) (e.g., composed of nitride, silicon nitride, silicon carbide, SiO2, aluminum nitride, aluminum oxide, and/or a photo-imagable polymer) arranged between the piezoelectric components (and the substrate 159) and the fluidic channel 170. In accordance with some embodiments, electrodes (e.g., the electrodes 125, FIG. 1A) are arranged in the fluidic channel 170. In some embodiments, the device layer 158 has a thickness in the range of 1 μm to 5 μm. In some embodiments, the handler layer 162 has a thickness in the range of 200 μm to 600 μm. In some embodiments, the passivation layer 156 has a thickness in the range of 0.01 μm to 1 μm.

In some embodiments, the fluidic channel 170 is defined by the optical layer 152, the bonding layer 154, and the device layer 158. In some embodiments, the channel 170 has a height between 10 μm and 1 mm (e.g., 10 μm, 50 μm, 100 μm, 200 μm, 600 μm, 1 mm, or within a range between any two of the aforementioned values). In some embodiments, the optical layer 152 has a thickness between 5 μm and 2 mm (e.g., 5 μm, 10 μm, 50 μm, 100 μm, 1 mm, 1.5 mm, 2 mm, or within a range between any two of the aforementioned values). In some embodiments, the substrate 159 is 500 μm thick. In some embodiments, the inlet channel 164 is defined in the substrate 159 (e.g., in addition to, or alternatively to, being defined in the optical layer 152).

In some embodiments, the bonding layer 154 is positioned between optical layer 152 and the substrate 159 (e.g., between the optical layer 152 and the device layer 158). In some embodiments, the bonding layer 154 is composed of polyvinylidene fluoride (PVDF), its copolymers, polyamides, and paralyne-C, polyimide and polyvinylidene chloride (PVDC), and/or diphenylalanine peptide nanotubes (PNTs). In some embodiments, the bonding layer 154 is adapted and/or positioned to adhere the optical layer 152 (e.g., a first substrate) and the substrate 159 (e.g., a second substrate) to one another. For example, if the bonding layer 154 is not included, then the optical layer 152 may not bond to the substrate 159. In some embodiments, the bonding layer 154 is composed of a photo-imagable material. For example, imaging the bonding layer 154 provides definition of the fluidic channel 170, such as its width, height, and curvature (e.g., which can improve the signal-to-noise ratio (SNR) for single cell sensing). In some embodiments, the bonding layer 154 is adapted and/or positioned to provide stress relief for the microfluidic device 100 (e.g., to prevent stress cracking when the chip is assembled in a package). In some embodiments, the bonding layer 154 is cured/hardened (e.g., submitted to multiple stages of curing/hardening). In some embodiments, the bonding layer 154 is submitted to a temperature that exceeds a transition temperature (e.g., 150 degrees Celsius) for the bonding layer 154, whereby the bonding layer 154 cures and bonds the optical layer 152 (e.g., glass) to the substrate 159 (e.g., silicon). In some embodiments, the bonding layer 154 is composed of a liquid or a dry film. The bonding layer 154 may be a negative or positive photo-resist. In some embodiments, the bonding layer 154 is composed of an epoxy (e.g., bisphenol-A) and/or polyimides with photo initiators (e.g., added to drive cross linking based on the wavelength of light).

FIGS. 1C, ID, 1E, and IF show cross-sectional views of the microfluidic device 100 at the input region 104, the regulation region 120, and a subregion of the output region 106 in accordance with some embodiments. FIG. 1C shows the input region 104 with the inlet channel 164 which, in some embodiments, is defined in the optical layer 152. The input region 104 further includes the set of piezoelectric actuators 105 situated below the inlet channel 164. FIG. 1D shows the regulation region 120 with one of the set of piezoelectric actuators 121a-121b. FIG. 1E shows the one subregion of the output region 106 with the outlet channel 166 and outlet 168 (e.g., one of the plurality of outlets 107a-107c) which, in some embodiments, is defined in the substrate 159. The one subregion further includes one subset of the set of piezoelectric actuators 109a-109c situated around the outlet 168.

In accordance with some embodiments, each of the set of piezoelectric actuators 105, the set of piezoelectric actuators 121a-121b, and the set of piezoelectric actuators 109a-109c includes a bottom electrode 174, top electrode 180, and piezoelectric layer 178. Each of the piezoelectric actuators further includes a bottom contact 176 coupled to the bottom electrode 174 and a top contact 188 coupled to the top electrode 180. In some embodiments, the bottom electrode 174 and/or the top electrode 180 are each composed of an electrically-conductive material (e.g., copper, aluminum, gold, platinum, strontium oxide (SRO), and/or titanium). In some embodiments, the bottom electrode 174 and/or the top electrode 180 has a thickness in the range of 10 nm to 50 nm.

In some embodiments, a first conductive layer is coupled to the top contact 188 and a second conductive layer is coupled to the bottom contact 176. For example, the first and second conductive layers comprise conductive routing configured to supply electrical signals (e.g., actuation signals) to the piezoelectric actuators. In some embodiments, the first and second conductive layers couple the respective piezoelectric actuator to control circuitry (e.g., the actuation circuitry 630). In some embodiments, the conductive layers are each composed of an electrically-conductive material (e.g., copper, aluminum, gold, or platinum). In some embodiments, a respective bond pad is coupled to each of the conductive layers (e.g., the respective bond pads provide off-chip electrical coupling to the piezoelectric actuators via the conductive layers). The passivation layer 156 separates the piezoelectric layer 178 and the electrodes 174 and 180 from the fluidic channel 170. In some embodiments, the passivation layer 156 is configured to prevent contact between the fluidic sample and the piezoelectric layer 178 and the electrodes 174 and 180. In some embodiments, an intermediate adhesion layer is arranged between the piezoelectric layer 178 and the passivation layer 156. In some embodiments, the intermediate adhesion layer is configured to match a mechanical impedance between the piezoelectric layer 178 and the passivation layer 156. In some embodiments, the intermediate adhesion layer is composed of metal (e.g., titanium). In some embodiments, the intermediate adhesion layer is configured to reduce cracking in the passivation layer 156. In some embodiments, the intermediate adhesion layer has a thickness in the range of 10 nm to 300 nm.

In some embodiments, the piezoelectric layer 178 has a thickness between 0.1 μm and 100 μm (e.g., 0.1 μm, 0.5 μm, 1 μm, 10 μm, 50 μm, 100 μm, or within a range between any two of the aforementioned values). In some embodiments, the piezoelectric layer 178 is positioned on a silicon-on-insulator (SOI) layer. In some embodiments, the SOI layer is connected to one or more of the contacts (e.g., the contact 176). In some embodiments, the piezoelectric layer 178 is composed of PZT and has a thickness in the range of 0.1 μm to 10 μm (e.g., 2 μm).

FIG. 1C also shows a plan view of a piezoelectric membrane 131 in accordance with some embodiments. The piezoelectric membrane 131 is positioned in the input region 104. The piezoelectric membrane 131 may include the substrate 159 (e.g., a buried oxide layer and/or a device layer), the passivation layer 156, the piezoelectric layer 178, and associated conductive layers (e.g., electrodes, vias, contacts, and/or routing). For example, the cross-sectional view in FIG. 1C illustrates the piezoelectric membrane 131 along the A-A′ diameter.

FIG. 1D shows a plan view of a piezoelectric membrane 132 in accordance with some embodiments. The piezoelectric membrane 132 is positioned in the regulation region 120. The piezoelectric membrane 132 may include the substrate 159, the passivation layer 156, the piezoelectric layer 178, and associated conductive layers (e.g., electrodes, vias, contacts, and/or routing). In some embodiments, the piezoelectric membrane 132 includes a contact 135 (e.g., the top contact 188) electrically coupled to a respective electrode (e.g., the top electrode 180). The electrode may be coupled to one or more piezoelectric layers to actuate the piezoelectric material, regulate the flow of the sample fluid, and/or manipulate the particles in the sample fluid. The cross-sectional view in FIG. 1D illustrates the piezoelectric membrane 132 along the B-B′ diameter.

FIG. 1E additionally shows a plan view of a piezoelectric membrane 133 in accordance with some embodiments. The piezoelectric membrane 133 is positioned in the output region 106. The piezoelectric membrane 133 may include the substrate 159, the passivation layer 156, the piezoelectric layer 178, and associated conductive layers (e.g., electrodes, vias, contacts, and/or routing). In some embodiments, the piezoelectric membrane 133 includes the contact 135 (e.g., the bottom contact 176) electrically coupled to the respective electrode (e.g., the bottom electrode 174), a contact 136 (e.g., the top contact 188) electrically coupled to a second electrode (e.g., the top electrode 180), and the outlet 168 (e.g., one of the plurality of outlets 107a-107c) (e.g., a nozzle). The first and second electrodes may be coupled to one or more piezoelectric layers to actuate the piezoelectric material and eject the sample fluid via the outlet 168. In some embodiments, the outlet 168 has a diameter of less than 200 μm (e.g., 30 μm, 60 μm, or 120 μm). The cross-sectional view in FIG. 1E illustrates the piezoelectric membrane 133 along the C-C′ diameter.

In some embodiments, the piezoelectric layers described herein are composed of polyvinylidene fluoride, gallium phosphate, sodium bismuth titanate, lead zirconate titanate, quartz, berlinite (AlPO4), sucrose (table sugar), rochelle salt, topaz, tourmaline-group minerals, lead titanate (PbTiO3), langasite (La3Ga5SiO14), gallium orthophosphate (GaPO4), lithium niobate (LiNbO3), lithium tantalate (LiTaO3), any of a family of ceramics with perovskite, tungsten-bronze, potassium niobate (KNbO3), sodium tungstate (Na2WO3), Ba2NaNb5O5, Pb2KNb5O15, sodium potassium niobate ((K,Na)NbO3) (e.g., NKN, or KNN), bismuth ferrite (BiFcO3), sodium niobate (NaNbO3), barium titanate (BaTiO3), bismuth titanate (Bi4Ti3O12), sodium bismuth titanate (NaBi(TiO3)2), zincblende crystal, GaN, InN, AlN, and/or ZnO. In some embodiments, a piezoelectric material is of any of BKT-BMT-BFO set, e.g., KNN such as (K0.5Na0.5)NbO3, BKT such as (Bi0.5K0.5)TiO3, BMT such as Bi(Mg0.5Ti0.5)O3, BFO such as BiFeO3, BNT such as (Bi0.5Na0.5)TiO3, and/or BT such as BaTiO3.

FIG. 1F illustrates a cross-sectional view of the regulation region 120 along a D-D′ diameter in accordance with some embodiments. In some embodiments, the regulation region 120 is defined by the optical layer 152, the substrate 159, and the bonding layer 154. In some embodiments, each of the set of piezoelectric actuators 121a-121b includes the bottom electrode 174, the top electrode 180, the piezoelectric layer 178, the bottom contact 176 coupled to the bottom electrode 174, and the top contact 188 coupled to the top electrode 180 (e.g., as described previously in reference to FIG. 1D). In some embodiments, the regulation region 120 further includes the passivation layer 156 coupled to the substrate 159 and configured to separate the piezoelectric layer 178 and the electrodes 174 and 180 from the fluidic channel 170. In some embodiments, of the set of piezoelectric actuators 121a-121b comprises two or more piezoelectric actuators (e.g., two actuators, as illustrated in FIG. 1F). For example, the set of piezoelectric actuators 121a-121b comprises at least one pair of actuators, each pair including a first actuator on one side of the fluidic channel 170 and a second actuator on a second side of the fluidic channel 170 (e.g., two or more pairs of actuators may be arranged on first and second sides (e.g., opposing sides) of the fluidic channel 170). In some embodiments, the set of piezoelectric actuators 121a-121b comprises actuators on alternating sides of the fluidic channel 170. In some embodiments, the set of piezoelectric actuators 121a-121b are arranged adjacent to and/or in the sensing region 110. In some embodiments, each actuator 121a-121b is fluidly connected to the fluidic channel 170 via one or more openings. In some embodiments, each of the one or more openings has a size that is of a same order of magnitude as the particles of the fluidic sample. In some embodiments, each actuator 121 is positioned within the fluidic channel 170 (e.g., on a bottom surface of the fluidic channel 170).

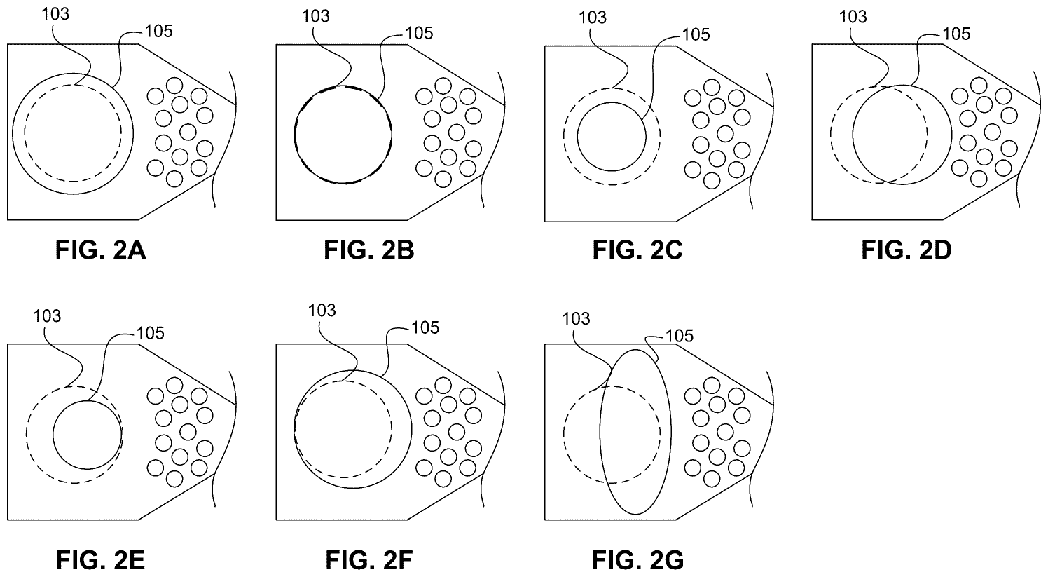

FIGS. 2A-2G illustrate alternative embodiments for a pattern of the set of piezoelectric actuators 105 in the input region 104 in accordance with some embodiments. FIG. 2A illustrates a first configuration in which the set of piezoelectric actuators 105 is aligned with the inlet 103 and has a larger diameter than a diameter the inlet 103 (e.g., as illustrated in FIG. 1A), in accordance with some embodiments. FIG. 2B illustrates a second configuration where the set of piezoelectric actuators 105 is aligned with the inlet 103 and has a same diameter as the diameter of the inlet 103. FIG. 2C illustrates a third configuration where the set of piezoelectric actuators 105 is aligned with the inlet 103 and has a smaller diameter than the diameter the inlet 103. FIG. 2D illustrates a fourth configuration where the set of piezoelectric actuators 105 is offset from the inlet 103 (e.g., a center the set of piezoelectric actuators 105 is closer to the regulation region 120 relative to the inlet 103) and has a same diameter as the diameter of the inlet 103. FIG. 2E illustrates a fifth configuration where the set of piezoelectric actuators 105 is offset from the inlet 103 (e.g., the center of the set of piezoelectric actuators 105 is closer to the regulation region 120 relative to the inlet 103) and has a smaller diameter than the diameter of the inlet 103. FIG. 2F illustrates a sixth configuration where the set of piezoelectric actuators 105 is offset from the inlet 103 (e.g., the center the set of piezoelectric actuators 105 is closer to the regulation region 120 relative to the inlet 103) and has a larger diameter than the diameter of the inlet 103. FIG. 2G illustrates a seventh configuration where the set of piezoelectric actuators 105 is offset from the inlet 103 (e.g., the center the set of piezoelectric actuators 105 is closer to the regulation region 120 relative to the inlet 103) and is oval in shape.

In accordance with some embodiments, a shape of the inlet 103 and/or the shape of the set of piezoelectric actuators 105 is different (e.g., circular, oval, rectangular, ring-shaped, etc.). In some embodiments, the pattern of the inlet 103 and/or the pattern of the set of piezoelectric actuators 105 is chosen based on a desired function of the input region 104, a parameter of the sample fluid, and/or a parameter of the particles. For example, a pattern and/or a relative location of the inlet 103 and/or the set of piezoelectric actuators may be selected to maximize dissociation of the particles of the fluid sample, achieve a desired laminar flow rate in the fluidic channel 102, and/or prevent bubble formation in the fluid sample, as desired.

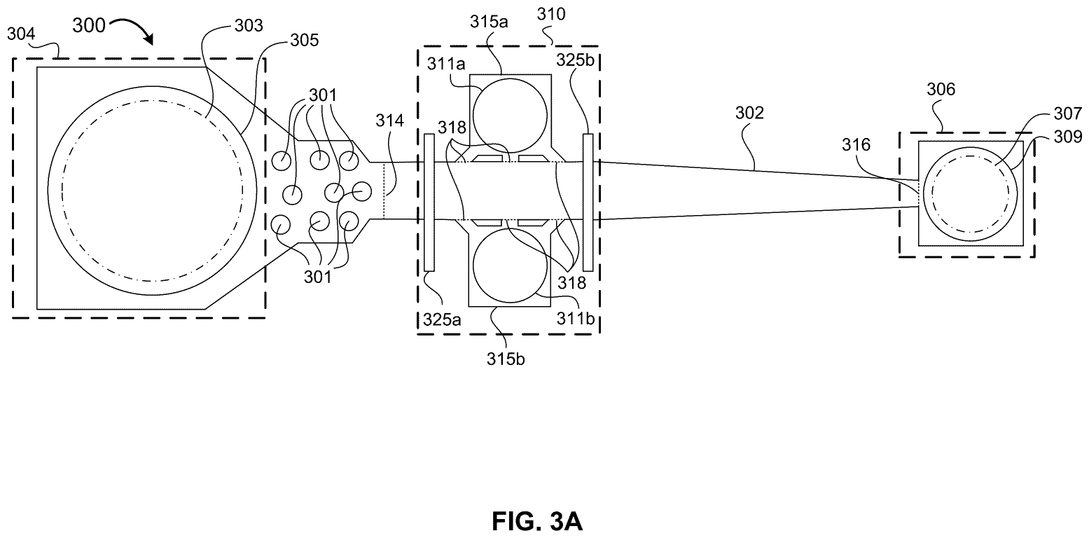

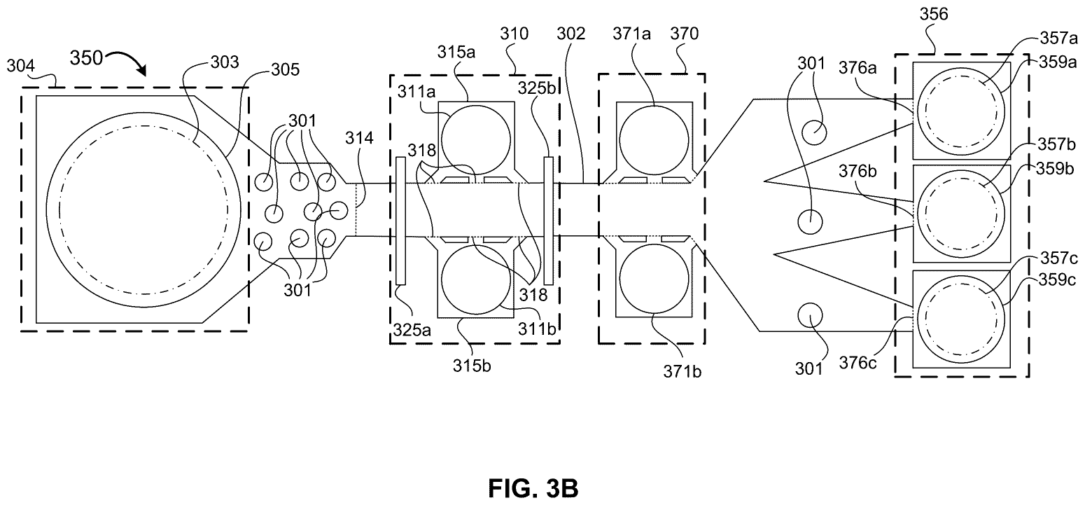

FIGS. 3A-3B illustrate plan views of a microfluidic device 300 and a microfluidic device 350, respectively, in accordance with some embodiments. The microfluidic device 300 and the microfluidic device 350 illustrate examples in which the microfluidic device has actuators within a sensing zone to adjust the orientation of particles passing through the sensing zone.

Similar to the microfluidic device 100, the microfluidic device 300 and the microfluidic device 350 each include a respective fluidic channel 302 (e.g., an instance of the fluidic channel 102, as described in reference to FIGS. 1A-1F) formed on a substrate (e.g., the substrate 159, as described in reference to FIGS. 1B-1F). In some embodiments, the fluidic channel 302 is formed by coupling a first substrate with at an indentation, recess, or notch with a second substrate such that the fluidic channel 302 is defined between the first substrate and the second substrate. The fluidic channel 302 has an inlet 303 (e.g., an instance of the inlet 103, as described in reference to FIGS. 1A-2G) and at least one outlet (e.g., FIG. 3A illustrates the fluidic channel 302 with an outlet 307, and FIG. 3B illustrates the fluidic channel 302 with a plurality of outlets 357a-357c). The locations of the inlet 303 and the at least one outlet shown with respect to the fluidic channel 302 in FIGS. 3A-3B are examples and in some other embodiments, the inlet 303 and the outlets are arranged at different orientations/locations with respect to the fluidic channel 302.

In some embodiments, a length of the fluidic channel 302 (e.g., measured from the inlet 303 to the outlet 307 and/or the plurality of outlets 357a-357c) is in the range of 1 mm to 50 mm (e.g., 15 mm). In some embodiments, a width of the microfluidic device 300 and/or the microfluidic device 350 is in the range of 0.2 mm to 50 mm (e.g., 0.7 mm). In some embodiments, a width of the fluidic channel 302 is configured based on a size of a particle to be analyzed. In some embodiments, the fluidic channel 302 includes one or more portions that have different respective widths. The microfluidic device 300 and/or the microfluidic device 350 further include an input region 304 (e.g., an instance of the input region 104, as described in reference to FIG. 1A) for receiving a sample fluid with particles as an input to the microfluidic device 300 and/or the microfluidic device 350 and providing the sample fluid from an inlet port to the fluidic channel 302 via the inlet 303. In accordance with some embodiments, the microfluidic devices 300 and 350 each include a plurality of pillars 301 (e.g., instances of the plurality of pillars 101, described in reference to FIG. 1A) adjacent to (or within) the input region 304. The microfluidic devices 300 and 350 include a set of piezoelectric actuators 305 (e.g., the set of piezoelectric actuators 105, as described in reference to FIGS. 1A-1F) at the input region 304 (e.g., around the inlet 303). In some embodiments, the set of piezoelectric actuators 305 is located adjacent to the inlet 303 and is configured to induce a laminar flow from the inlet 303 toward the at least one outlet. In some embodiments, the input region 304 is configured to control a rate flow of the particles in the fluid sample. For example, an input opening 314 between the input region 304 and the fluidic channel 302 is configured to allow a limited number of particles into the fluidic channel 302 at a time (e.g., a size of the particles and a size of the input opening 314 are on a same order of magnitude).

The microfluidic device 300 in FIG. 3A further includes an output region 306 for collecting at least a portion of the sample fluid from the fluidic channel 302 and ejecting or delivering the sample fluid portion via the outlet 307 (e.g., a nozzle) for disposal or further processing or analysis of the sample fluid. The output region 306 includes a set of piezoelectric actuators 309, located adjacent to the outlet 307 for ejecting a portion of the sample fluid in the fluidic channel 302. In accordance with some embodiments, microfluidic device 300 includes a plurality of pillars 301 adjacent to (or within) the output region 306.

The microfluidic device 350 in FIG. 3B further includes an output region 356 for collecting at least a portion of the sample fluid from the fluidic channel 302 and ejecting or delivering the at least a portion of the sample fluid via the plurality of outlets 357a-357c (e.g., instances of the plurality of outlets 107a-107c, as described in reference to FIG. 1A) for disposal or further processing or analysis. In accordance with some embodiments, the output region 356 includes a plurality of output subregions, each subregion including one of the plurality of outlets 357a-357c. The shape and size of the output region 356 and the output subregions in FIG. 3B are mere examples. The output region 356 includes a set of piezoelectric actuators 359a-359c (e.g., instances of the set of piezoelectric actuators 109a-109c, as described in reference to FIG. 1A), located adjacent to each of the plurality of outlets 357a-357c for ejecting a portion of the fluid in the fluidic channel 302. In accordance with some embodiments, the microfluidic device 350 includes a plurality of pillars 301 adjacent to (or within) the output region 356. In some embodiments, each output subregion includes a subset of the set of piezoelectric actuators 359a-359c, each subset adjacent to a respective outlet of the plurality of outlets 357a-357c. As such, different portions of the sample fluid may be collected at, and ejected from, a corresponding output subregion. In some embodiments, the microfluidic device 350 is configured such that each output subregion, and each outlet of the plurality of outlets 357a-357c, is associated with a type of particle and/or a quality of the particles in the fluid sample. For example, a regulation region 370 is configured to cause different types of particles in the fluid sample to flow to different outlets of the plurality of outlets 357a-357c. Additionally, a plurality of output openings 376a-376c between the fluidic channel 302 and each respective output subregion is configured to allow a limited number of each of the different types of particles into each respective output subregion at a time (e.g., the size of each of the different types of particles and a respective size of each of the plurality of output openings 376a-376c are on a same order of magnitude).

The microfluidic devices 300 and 350 further include the sensing region 310 for sensing one or more properties of the particles in fluid sample. In some embodiments, the one or more properties include an impedance of the particle. In some embodiments, the sensing region 310 is sized such that only a single particle of the sample fluid is positioned in the sensing region 310 at a given time (e.g., each particle can be sensed separately and independently in the sensing region 310). In some embodiments, the sensing region 310 includes a set of electrodes 325a-325b and/or other sensing elements for sensing the one or more properties. In some embodiments, the set of electrodes 325a-325b is configured to detect data sufficient to construct a 3D electrical phenotypic image of the particle. In some embodiments, the set of electrodes 325a-325b is configured to provide a non-uniform electric field (e.g., not constant in a vertical direction) across the fluidic channel 302. In some embodiments, the sensing region 310 further includes a set of piezoelectric actuators 311a-311b configured to manipulate particles in the sensing region 310 (e.g., levitating, rotating, localizing, and/or deflecting the particles). In some embodiments, the set of piezoelectric actuators 311a-311b is configured to slow/hold the at least one particle in the sensing region 310 and rotate the particle while it is within the sensing region 310 (e.g., allowing for a detailed analysis of the at least one particle at various orientations). In some embodiments, the set of piezoelectric actuators 311a-311b is configured to cause a transient disruption of the laminar flow of the fluid sample through the sensing region 310.

The position of the sensing region 310, the set of electrodes 325a-325b, and the set of piezoelectric actuators 311a-311b may be varied along the length of the fluidic channel 302. For example, in some circumstances it may be beneficial to have equal distances between each electrode of the set of electrodes 325a-325b to acquire accurate measurements. In some embodiments, the set of electrodes 325a-325b, in conjunction with the set of piezoelectric actuators 311a-311b, is configured to detect data sufficient to conduct a 3D scan of the particle. In some embodiments, the set of electrodes 325a-325b detect electrical signals of particles (e.g., cells) flowing through the fluidic channel 302 adjacent to the set of electrodes 325a-325b. In some embodiments, the set of electrodes 325a-325b is configured to operate as particles move through the sensing region 310. In some embodiments, the set of electrodes 325a-325b are configured to operate in an alternating pattern with the set of piezoelectric actuators 311a-311b so as to reduce noise from the set of piezoelectric actuators 311a-311b affecting the measurements of the set of electrodes 325a-325b. For example, the set of piezoelectric actuators 311a-311b may operate at a relatively high voltage (e.g., greater than 1 V, 10 V, 30 V, or 50 V) to drive actuation, which can introduce noise into the sensing data in the set of electrodes 325a-325b if operating concurrently.

In some embodiments, the microfluidic devices 300 and 350 include readout circuitry (e.g., driver/readout circuitry 640, described with respect to FIG. 6) electrically coupled with the set of electrodes 325a-325b. In some embodiments, the readout circuitry receives electrical signals from the set of electrodes 325a-325b and relays the electrical signals (with or without processing, such as filtering) to one or more processors of, or operationally connected with, the microfluidic device. The position of the sensing region 310, the set of electrodes 325a-325b, and the set of piezoelectric actuators 311a-311b in FIGS. 3A-3B are mere examples and in various embodiments these components may be located in different positions and/or orientations.

In some embodiments, the set of piezoelectric actuators 311a-311b are arranged between the set of electrodes 325a-325b (e.g., as illustrated in FIGS. 3A-3B). For example, two piezoelectric membranes are located adjacent to, or within, the sensing region 310. In some embodiments, the set of piezoelectric actuators 311a-311b are coplanar with the fluidic channel 302 (e.g., as illustrated in FIGS. 3A-3B). In some embodiments, the set of piezoelectric actuators 311a-311b are positioned above and/or below the fluidic channel 302. For example, the set of piezoelectric actuators 311a-311b includes multiple pairs of piezoelectric actuators, and each pair includes a first piezoelectric actuator on a first side of the fluidic channel 302 and a second piezoelectric actuator on a second side of the fluidic channel 302. In some embodiments, the set of piezoelectric actuators 311a-311b includes piezoelectric actuators on alternating sides of the fluidic channel 302. In some embodiments, the set of piezoelectric actuators 311a-311b comprises a first piezoelectric actuator having a first size and a first shape (e.g., rectangular, square, circular, oval, annular, etc.), and a second piezoelectric actuator having a second size and a second shape. For example, at least one of the second size and the second shape is different than the first size and the first shape.

In some embodiments, the microfluidic devices 300 and 350 include actuation circuitry (e.g., actuation circuitry 630, described with respect to FIG. 6) electrically coupled with the set of piezoelectric actuators 311a-311b. In some embodiments, the actuation circuitry sends and/or receives electrical signals to/from the set of piezoelectric actuators 311a-311b and relays the electrical signals (with or without processing, such as filtering) from/to one or more processors of, or operationally connected with, the microfluidic device. In some embodiments, the actuation circuitry adjusts operation of the set of piezoelectric actuators 311a-311b based on data from the set of electrodes 325a-325b. In some embodiments, the actuation circuitry is configured to control operation of the set of piezoelectric actuators 305, the set of piezoelectric actuators 311a-311b, the set of piezoelectric actuators 371a-371b, and/or the set of piezoelectric actuators 359a-359c to control sample dissociation, flow rate, sample rotation, and/or sample ejection. In some embodiments, operation of the set of piezoelectric actuators 311a-311b is governed by feedback from a control unit. For example, once the particle enters the sensing region 310 (e.g., passes an electrode 325a of the set of electrodes 325a-325b), the control circuitry detects the particle's presence and sends signals to the set of piezoelectric actuators 311a-311b in the sensing region 310 to start the actuation process with various waveforms (e.g., while the particle is being sensed).

In accordance with some embodiments, the microfluidic devices 300 and 350 further include one or more cavities 315a-315b located in the sensing region 310. In some embodiments, the one or more cavities 315a-315b are formed by coupling the first substrate with an indentation, recess, or notch with the second substrate so that the one or more cavities 315a-315b are defined between the first substrate and the second substrate (e.g., the same method the fluidic channel 302 is formed). In some embodiments, the cavities 315a-315b are formed by coupling the first substrate with the second substrate via a bonding layer (e.g., composed of a polymer material). Each cavity of the one or more cavities 315a-315b includes at least one actuator of the set of piezoelectric actuators 311a-311b. For example, FIGS. 3A-3B illustrate the sensing region 310 including two cavities, each cavity including one actuator of the set of piezoelectric actuators 311a-311b. In some embodiments, each cavity is sized to be as large as a size of the one actuator (e.g., as illustrated in FIGS. 3A-3B). In some embodiments, each of the one or more cavities 315a-315b is fluidically connected to the fluidic channel 302 by at least one cavity opening 318. For example, each of the one or more cavities 315a-315b are fluidically connected to the fluidic channel 302 by three cavity openings (e.g., as illustrated in FIGS. 3A-3B). In some embodiments, a first opening of the at least one cavity opening 318 is angled upstream from the actuator, a second opening of the at least one cavity opening 318 is parallel to the actuator, and a third opening of the at least one cavity opening 318 is angled downstream from the actuator (e.g., as illustrated in FIGS. 3A-3B). In some embodiments, a width of the at least one cavity opening 318 is configured in accordance with a size of a particle (e.g., a width of the particle and a width of the at least one cavity opening 318 are on a same order of magnitude). In some embodiments, the cavity openings 318 are configured to allow acoustic waves from the actuators to interact with the particles while in the sensing region 310 (e.g., rotate and/or move the particles).

In some embodiments, respective actuator(s) of the set of piezoelectric actuators 311a-311b are configured to rotate the particle while the particle in the sensing region 310. In some embodiments, respective actuator(s) of the set of piezoelectric actuators 311a-311b are further configured to slow the progression of the particle through the sensing region 310 (e.g., so as to increase an amount of time that the particle may be manipulated and sensed). While the particle is within the sensing region 310, the set of electrodes 325a-325b sense one or more properties of the particle. For example, rotating the particle allows the set of electrodes 325a-325b to measure the particle at different orientations (e.g., to perform a 3D scan on the particle). As another example, slowing/holding the particle also allows the set of electrodes 325a-325b to apply a plurality of distinct electric fields (e.g., electric fields with distinct frequencies and/or waveforms) to the particle to sense different properties. In an example, the set of piezoelectric actuators 311a-311b is configured to cause a particle of the sample fluid to rotate at least 90 degrees so that a 3D scan of the particle may be performed by the set of electrodes 325a-325b. In some embodiments, the set of piezoelectric actuators 311a-311b are configured to move the particle to different portions the fluidic channel 302 (e.g., levitate and/or deflect the particle) by causing a transient disruption of the laminar flow of the fluid sample through the sensing region 310. In some embodiments, the set of piezoelectric actuators 311a-311b are configured to operate at different frequencies and/or waveforms to impart rotational force to the particles of the sample fluid.

The microfluidic device 350 further includes a regulation region 370 (e.g., an instance of the regulation region 120, as described in reference to FIG. 1A) for regulating the flow of the sample fluid and/or manipulating the particles (e.g., deflecting the particles to particular outlet regions). In some embodiments, the regulation region 370 overlaps with (e.g., and/or is the same as) the sensing region 310. That is, in some embodiments, the set of piezoelectric actuators 311a-311b are configured to deflect the particles to particular outlets. The regulation region 370 in FIG. 3B includes a set of piezoelectric actuators 371a-371b (e.g., an instance of the set of piezoelectric actuators 121a-121b, described in reference to FIGS. 1A-1F). In some embodiments, the set of piezoelectric actuators 371a-371b is located between the sensing region 310 and the output region 356. In some embodiments, the set of piezoelectric actuators 371a-371b is located between the sensing region 310 and the plurality of outlets 357a-357c. In some embodiments, the set of piezoelectric actuators 371a-371b include actuators arranged on opposite sides of the fluidic channel 302 (e.g., the two actuators illustrated in FIG. 3B). In some embodiments, the set of piezoelectric actuators 371a-371b are configured to deflect the particles in the fluid sample to a specified output subregion of the output region 356 based on one or more properties of the particle in the fluid sample (e.g., each output subregion corresponding to a particular type of particle). For example, two actuators placed on either side of the fluidic channel 302 operate in tandem to either deflect the particles downstream into one of the output subregions and/or regulate the location of the particles (e.g., sorting particles of a fluid sample). The manipulation of the particles by the set of piezoelectric actuators 371a-371b may be based on instructions from the measurement/analysis circuitry 650 and/or the actuation circuitry 630. The manipulation of the particles may be based on information from the sensing region 310 (e.g., the particles are sorted based on the measured properties). In some embodiments, the set of piezoelectric actuators 371a-371b include more than two piezoelectric actuators. In some embodiments, piezoelectric actuators of the set of piezoelectric actuators 371a-371b are offset from one another (e.g., the piezoelectric actuator 371a is positioned upstream from the piezoelectric actuator 371b, or vice versa). In some embodiments, piezoelectric actuators of the set of piezoelectric actuators 371a-371b have differing sizes and/or shapes.

In some embodiments, each of the four sets of piezoelectric actuators (the set of piezoelectric actuators 305, the set of piezoelectric actuators 311a-311b, and/or the set of piezoelectric actuators 371a-371c, and the set of piezoelectric actuators 309 or the set of piezoelectric actuators 359a-359c) includes one or more piezoelectric actuators (e.g., a piezo micro-electro-mechanical system (MEMS) actuator). In some embodiments, each of the four sets of piezoelectric actuators includes two or more piezoelectric actuators. In some embodiments, each of the four sets of piezoelectric actuators includes piezoelectric actuator(s) having differing sizes and/or shapes from other sets. In some embodiments, each of the four sets of piezoelectric actuators have a thickness in a range of 0.1 μm to 5 μm. In some embodiments, each of the four sets of piezoelectric actuators is arranged on a membrane (e.g., the membrane is composed of a substrate with a thickness in a range of 1 μm to 5 μm).

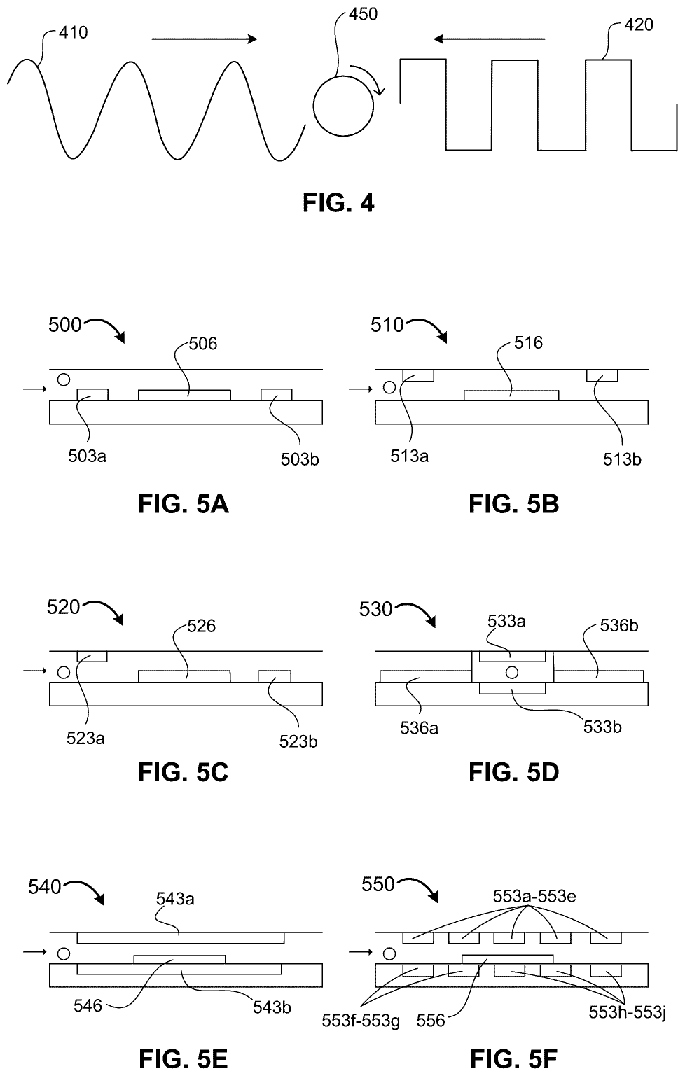

FIG. 4 illustrates a plurality of acoustic waves (e.g., a wave 410 and a wave 420) colliding at a particle 450 (e.g., a cell) of the sample fluid in accordance with some embodiments. The colliding of the plurality of acoustic waves at the particle 450 cause the particle 450 to levitate, rotate, and/or deflect (e.g., in three dimensions). In some embodiments, the waves are applied to the particle in a sensing region (e.g., the sensing region 310) of a fluidic channel (e.g., the fluidic channel 302) of a microfluidic device (e.g., the microfluidic device 300 or 350). In an example, the plurality of waves are configured to cause the particle 450 to rotate at least 90 degrees while in the sensing region 310 such that a 3D scan of the particle may be performed. In some embodiments, the plurality of acoustic waves cause the particle 450 to levitate, rotate, and/or deflect by creating a drag force at the particle 450 (e.g., a symmetric drag force to levitate and/or deflect the particle 450 and/or the asymmetric drag force to rotate the particle 450).

In some embodiments, each of the plurality of acoustic waves is produced by a respective piezoelectric actuator (e.g., each of the set of piezoelectric actuators 311a-311b) of the microfluidic device (e.g., the microfluidic device 300 or 350). For example, a first piezoelectric actuator provides the wave 410 (e.g., a sinusoidal wave with a first frequency and a first amplitude) and a second piezoelectric actuator provides the wave 420 (e.g., a square wave with a second frequency and a second amplitude), distinct from the wave 410, to the particle 450. In some embodiments, the wave 410 and the wave 420 are selected to cause constructive interference at the particle 450 (e.g., to adjust positioning of the particle) or cause destructive interference at the particle 450 (e.g., to cause rotation of the particle). In some embodiments, the set of piezoelectric actuators 311a-311b includes a first subset of piezoelectric actuators configured to cause rotation of the particle 450 and a second subset of piezoelectric actuators configured to adjust positioning of the particle 450. In some embodiments, the set of piezoelectric actuators 311a-311b includes a piezoelectric membrane located on the floor of the fluidic channel 302 and configured to cause/adjust levitation of the particle 450 as it flows through the sensing region 310. In some embodiments, the set of piezoelectric actuators 311a-311b is configured to cause the particle 450 to travel through the sensing zone via a Eulerian trajectory.

In some embodiments, each respective piezoelectric actuator is configured to selectively operate in a plurality of different modes. For example, each respective piezoelectric actuator may be configured to selectively operate in a continuous mode, a triggered mode, a centering mode, and/or a sorting mode. For example, in the continuous mode one or more piezoelectric actuators are continuously operating at a frequency that is higher than the frequency of passage of the particle 450 through the sensing region 310. As another example, in the triggered mode the one or more piezoelectric actuators operate in response to a trigger (e.g., the particle entering the sensing region 310). As another example, in the centering mode the one or more piezoelectric actuators operate to center the particle 450 in the sensing region 310 (e.g., the drag forces imparted to the particle 450 from the one or more piezoelectric actuators cancel each other out and the particle 450 is centered in the sensing region 310). As another example, in the sorting mode, the one or more piezoelectric actuators operate at a higher amplitude in order to alter a trajectory of the particle 450 (e.g., thereby deflecting the particle 450 to a specified output subregion of the output region 356).

Actuation circuitry (e.g., the actuation circuitry 630 in FIG. 6) of the microfluidic device control each respective piezoelectric actuator to selectively cause rotation and/or adjust position of the particle 450 in response to respective control signals, in accordance with some embodiments. For example, a frequency, a wave-type, and/or an amplitude of operation of each respective piezoelectric actuator may be controlled (e.g., adjusted) by the actuation circuitry. In some embodiments, each respective piezoelectric actuator produces a respective acoustic wave (e.g., the wave 410 or the wave 420) by actuating a respective piezoelectric membrane with a respective actuation signal. In some embodiments, each respective actuation signal is provided by actuation circuitry (e.g., the actuation circuitry 630 in FIG. 6) of the microfluidic device.

In some embodiments, each respective piezoelectric actuator is configured to generate acoustic waves (e.g., via oscillation) that are perpendicular to the direction of travel of the particle 450 (e.g., perpendicular to a flow direction in the fluidic channel). In some embodiments, each respective piezoelectric actuator is configured to have an oscillation period that is less than the residence time of the particle 450 in the sensing region 310. In some embodiments, each respective piezoelectric actuator is configured to produce a configurable acoustic wave (e.g., in a range of 1 kHz to 100 GHz). In some embodiments, producing a configurable acoustic wave in a particular frequency comprises vibrating the piezoelectric membrane at the particular frequency. In some embodiments, the frequency range is based on a type of the particle 450 and/or an intended operation (e.g., levitating, rotating, and/or deflecting). As an example, a MHz subrange may be used to levitate the particle 450, a kHz and/or MHz subrange may be used to rotate the particle 450, and a kHz range may be used to deflect the particle 450. In some embodiments, the configurable acoustic wave may be a sinusoidal wave, a square wave, a triangle wave, a sawtooth wave, a pulse wave, and/or any combination thereof.

FIGS. 5A-5F illustrate a plurality of patterns for arranging electrodes (e.g., the set of electrodes 325a-325b, described in reference to FIGS. 3A-3B) and piezoelectric actuators (e.g., the set of piezoelectric actuators 311a-311b, as described in reference to FIGS. 3A-3B) for sensing the one or more properties of a particle in a sample fluid in accordance with some embodiments. In some embodiments, the plurality of patterns correspond to arrangements of electrodes and piezoelectric actuators in the sensing region 310.

FIG. 5A illustrates a pattern 500 including two electrodes 503a-503b and one piezoelectric actuator 506, in accordance with some embodiments. The two electrodes 503a-503b and the one piezoelectric actuator 506 are arranged on a same side of the sensing region 310 in FIG. 5A. The pattern 500 may be relatively easy to fabricate (e.g., due to having less layers) but results in a non-uniform electrical field (e.g., in the vertical direction).

FIG. 5B illustrates a pattern 510 including two electrodes 513a-513b and one piezoelectric actuator 516, in accordance with some embodiments. The two electrodes 513a-513b are arranged on the first side of the sensing region 310 and the one piezoelectric actuator 516 is arranged on the second side of the sensing region 310, opposite of the first side, as illustrated in FIG. 5B (e.g., and configured to selectively levitate particles).

FIG. 5C illustrates a pattern 520 including two electrodes 523a-523b and one piezoelectric actuator 526, in accordance with some embodiments. The electrodes 523a-523b are arranged on the first side and the second side, opposite of the first side, of the sensing region 310, respectively. The piezoelectric actuator 526 is arranged on the second side of the sensing region 310 in FIG. 5C (e.g., and configured to selectively levitate particles).

FIG. 5D illustrates a pattern 530 including two electrodes 533a-533b and two piezoelectric actuators 536a-536b, in accordance with some embodiments. The two electrodes 533a-533b are arranged on the first side of the sensing region 310 and each of the two piezoelectric actuators 536a-536b is arranged on the first side and the second side, opposite of the first side, of the sensing region 310, respectively. In accordance with some embodiments, each of the two piezoelectric actuators 536a-536b is arranged opposite of one another in FIG. 5D. The piezoelectric actuators 536a-536b may be configured to move and/or manipulate (e.g., rotate and/or deflect) particles while the electrodes 533a-533b sense the particles.

FIG. 5E illustrates a pattern 540 including two electrodes 543a-543b and one piezoelectric actuator 546, in accordance with some embodiments. Each of the two electrodes 543a-543b is arranged on the first side and the second side, opposite of the first side, of the sensing region 310, respectively. In some embodiments, each of the two electrodes 543a-543b is arranged opposite of one another. The piezoelectric actuator 546 is arranged on the second side of the sensing region 310 in FIG. 5E (e.g., and configured to selectively levitate particles).

FIG. 5F illustrates a pattern 550 including ten electrodes 553a-553j and one piezoelectric actuator 556, in accordance with some embodiments. A first portion of the ten electrodes 553a-553j is arranged on the first side of the sensing region 310, and a second portion of the ten electrodes 553a-553j is arranged on the second side, opposite of the first substrate of the sensing region 310. For example, five of the ten electrodes 553a-553j are arranged on the first side the sensing region 310 and another five of the ten electrodes 553a-553j are arranged on the second side the sensing region 310. In some embodiments, the first portion and the second portion arranged opposite of one another. The piezoelectric actuator 556 is arranged on the second side of the sensing region 310 in FIG. 5F (e.g., and configured to selectively levitate particles). Thus, the electrodes 553a-553j in FIG. 5F correspond to splitting the electrodes 543a-543b in FIG. 5E (e.g., to provide greater control over the electrical fields and/or sensing).

FIG. 6 is a block diagram illustrating an example system for a microfluidic device in accordance with some embodiments. In some embodiments, a device (e.g., the microfluidic device 300 or 350) includes one or more processors 602 (e.g., one or more microcontrollers (MCUs), one or more CPUs, and/or other types of control circuitry) and memory 604. In some embodiments, the memory 604 includes instructions for execution by the one or more processors 602. In some embodiments, the stored instructions include instructions for providing actuation signals to one or more sets of piezoelectric actuators (e.g., the set of piezoelectric actuators 305, the set of piezoelectric actuators 311a-311b, the set of piezoelectric actuators 309, the set of piezoelectric actuators 371a-371b, and/or the set of piezoelectric actuators 359a-359c). In some embodiments, the actuation signals for the different piezoelectric actuators are configured such that each of the piezoelectric actuators create oscillations at a different frequency. For example, one or more of the piezoelectric actuators may operate at a frequency in the range between 1 kHz and 100 kHz, for example, based on desired flow rates. In some embodiments, the stored instructions include instructions for providing activation signals to the electrodes 605 for charging particles flowing through the fluidic channel 302 so that the particles can be manipulated with an electrical field. In some embodiments, the device also includes an electrical interface 606 coupled with the one or more processors 602 and the memory 604. The electrical interface 606 couples the processor(s) 602 and/or the memory 604 to additional circuitry of the device (e.g., actuation circuitry 630, driver circuitry 640, and measurement/analysis circuitry 650). In some embodiments, the device further includes actuation circuitry 630, which is coupled to one or more piezoelectric actuators 601, such as the set of piezoelectric actuators 305, the set of piezoelectric actuators 311a-311b, the set of piezoelectric actuators 309, the set of piezoelectric actuators 371a-371b, and/or the set of piezoelectric actuators 359a-359c. For example, the actuation circuitry 630 may be coupled to the piezoelectric actuator(s) 601 via one or more contacts (e.g., the contacts 176 and 188). In some embodiments, the actuation circuitry 630 sends electrical signals to the piezoelectric actuators to initiate/control actuation of the piezoelectric actuators.

In some embodiments, the device further includes driver circuitry 640, which is coupled to one or more of the electrodes 605 (e.g., one or more of the electrodes 325a-325b). For example, the driver circuitry 640 sends electrical signals to the one or more electrodes to generate an electrical field using the one or more electrodes for charging particles flowing through the fluidic channel. In some embodiments, the device further includes readout circuitry (e.g., the driver/readout circuitry 640), which is coupled to one or more of the electrodes 605 (e.g., one or more of the electrodes 325a-325b). In some embodiments, the driver/readout circuitry is further coupled to one or more of the piezoelectric actuators 601 (e.g., to adjust actuation of the actuators based on readout data). For example, the driver/readout circuitry 640 may be coupled to the piezoelectric actuator(s) 601 via one or more contacts (e.g., the contacts 176 and 188). In some embodiments, the readout circuitry receives electrical signals from the one or more electrodes 605 and/or the piezoelectric actuators 601 and provides the electrical signals (with or without processing) to the one or more processors 602 via the electrical interface 606.

In some embodiments, the device further includes measurement/analysis circuitry 650 coupled to one or more of the electrodes 605 (e.g., one or more of the electrodes 325a-325b) and/or one or more of the piezoelectric actuator(s) 601 (e.g., any of the piezoelectric actuators described herein). In some embodiments, the measurement/analysis circuitry 650 is configured to determine electrical impedance of particles in the microfluidic channel (e.g., the fluidic channel 302). In some embodiments, the measurement/analysis circuitry 650 is coupled to the actuation circuitry 630 (e.g., via the electrical interface 606) and informs the actuation circuitry 630 how to actuate the one or more piezoelectric actuators 601 (e.g., based on the impedance measurements). In some embodiments, the measurement/analysis circuitry 650 is coupled to the driver/readout circuitry 640 (e.g., via the electrical interface 606) and informs the driver/readout circuitry 640 how to drive the electrodes 605 (e.g., based on the impedance measurements). In some embodiments, the actuation circuitry 630 is configured to adjust actuation of one or more piezoelectric actuators (e.g., adjust frequency and/or magnitude) based on particle analysis results from the measurement/analysis circuitry 650. For example, if the measurement/analysis circuitry 650 indicate that a clump of particles is present, the one or more piezoelectric actuators 601 are configured (e.g., actuated at a preset frequency range) to break up the clump.

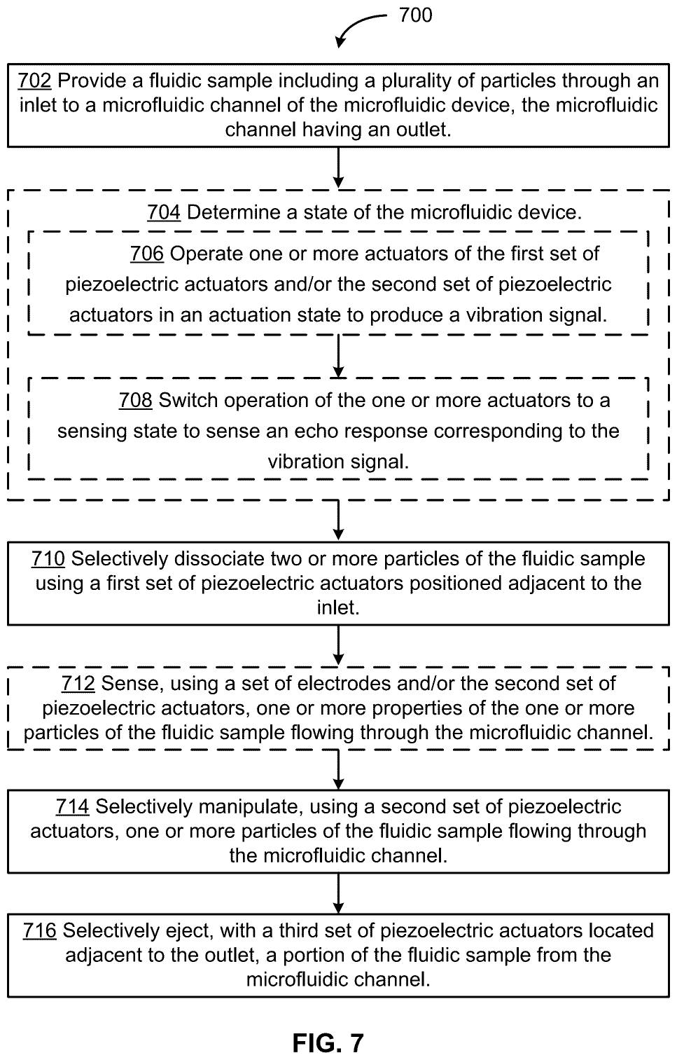

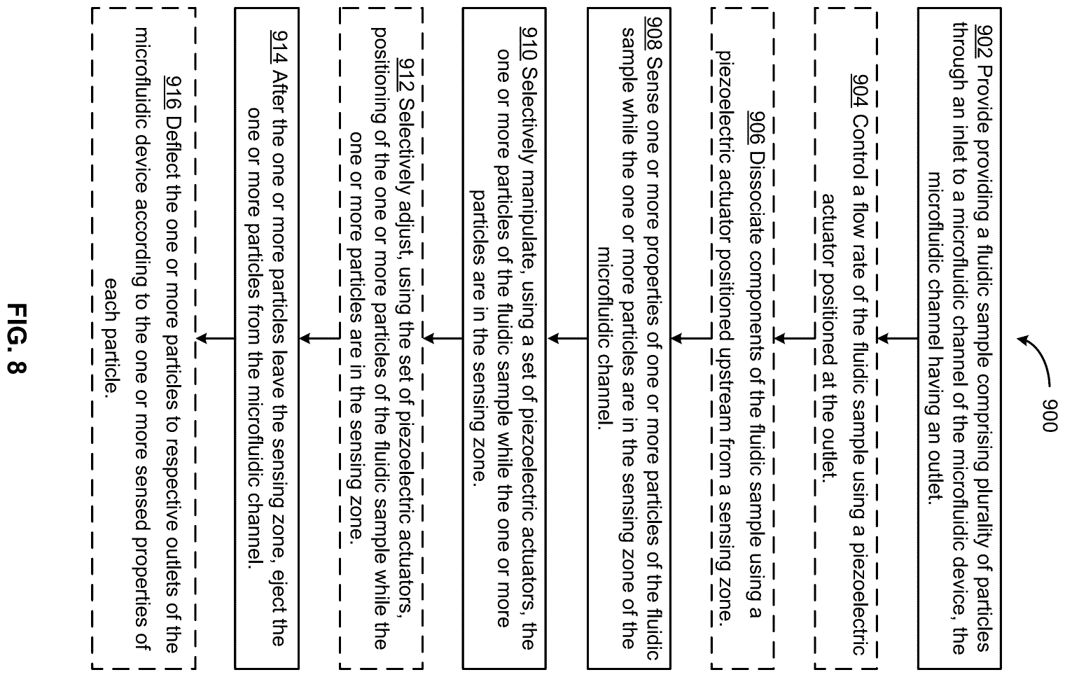

FIG. 7 is a flow diagram illustrating a method 700 of flow control of cells or particles in a microfluidic channel (e.g., the fluidic channel 102 and/or the fluidic channel 170) in accordance with some embodiments. In some embodiments, the method 700 is performed at a microfluidic device (e.g., the microfluidic device 100).

The method 700 includes (702) providing a fluidic sample comprising plurality of particles (e.g., cells, molecules, and/or other types of particles) through an inlet (e.g., inlet 103) to a microfluidic channel (e.g., fluidic channel 102) of a microfluidic device (e.g., the microfluidic device 100), the microfluidic channel having an outlet (e.g., one of the plurality of outlets 107a-107c). For example, a sample fluid with particles is provided in the fluidic channel 102 with the inlet 103 and the plurality of outlets 107a-107c.

In some embodiments, the method 700 further includes (704) determining a state of the microfluidic device. In some embodiments, determining the state of the microfluidic device includes (706) operating one or more actuators of the first set of piezoelectric actuators (e.g., the set of piezoelectric actuators 105) and/or the second set of piezoelectric actuators (e.g., the set of piezoelectric actuators 121a-121b) in an actuation state to produce a vibration signal. In some embodiments, determining the state of the microfluidic device further includes (708) switching operation of the one or more actuators to a sensing state to sense an echo response corresponding to the vibration signal. For example, if there is a large clump of cells sitting on the one or more actuators, then its response will change. In some embodiments, a first subset of actuators operate in the actuation state to produce one or more vibration signals and a second subset of actuators operate in the sensing state to sense echo responses of the one or more vibration signals. As an example, the acoustic signal received by the second subset of piezoelectric actuators after a rebound indicates a viscosity and/or density of the sample and can be used to assess the agglomeration/coagulation/clogging of the sample.

The method 700 includes (710) selectively dissociating two or more particles of the fluidic sample using a first set of piezoelectric actuators positioned adjacent to the inlet.

In some embodiments, the method 700 includes (712) sensing, using a set of electrodes (e.g., electrodes 652) and/or the second set of piezoelectric actuators (e.g., piezoelectric actuators 654), one or more properties of the one or more particles of the fluidic sample flowing through the microfluidic channel. In some embodiments, the method 700 further includes selectively providing actuation signals (e.g., via the actuation circuitry 630) to the first, second, and third sets of piezoelectric actuators based on obtained sensing data (e.g., via the measurement/analysis circuitry 650). In some embodiments, the actuation signals are generated to create an oscillation frequency in the actuators that is based on a fluid composition (e.g., size and/or concentration of particles) in the microfluidic channel. For example, the third set of actuators may be configured to oscillate such that only 1 particle is ejected at a time. For example, the sense signals may include information about the state of the fluid.

The method 700 includes (714) selectively manipulating, using a second set of piezoelectric actuators, one or more particles of the fluidic sample flowing through the microfluidic channel. In some embodiments, selectively manipulating, using the second set of piezoelectric actuators, the one or more particles of the fluidic sample flowing through the microfluidic channel comprises selectively levitating, rotating, and/or sorting the one or more particles. In some embodiments, selectively manipulating, using the second set of piezoelectric actuators, the one or more particles of the fluidic sample flowing through the microfluidic channel comprises adjusting a frequency of operation of the second set of piezoelectric actuators to perform different types of manipulation.

The method 700 includes (716) selectively ejecting, with a third set of piezoelectric actuators (e.g., the set of piezoelectric actuators 109a-109c) located adjacent to the outlet, a portion of the fluidic sample from the microfluidic channel. In some embodiments, the third set of piezoelectric actuators and the outlet are sized to be able to eject particles with a diameter ranging from 2 μm to 50 μm.

FIG. 8 is a flow diagram illustrating a method 900 of flow control of particles in a microfluidic channel (e.g., the fluidic channel 102, the fluidic channel 170, and/or the fluidic channel 302) in accordance with some embodiments. In some embodiments, the method 900 is performed at a microfluidic device (e.g., the microfluidic device 100, the microfluidic device 300, and/or the microfluidic device 350).

The method 900 includes (902) providing a fluidic sample comprising plurality of particles (e.g., cells, molecules, and/or other types of particles) through an inlet (e.g., the inlet 103 and/or the inlet 303) to a microfluidic channel (e.g., the fluidic channel 102 and/or the fluidic channel 302) of the microfluidic device, the microfluidic channel having an outlet (e.g., one of the plurality of outlets 107a-107c, the outlet 307, and/or the plurality of outlets 357a-357c). For example, a sample fluid with particles is provided in the fluidic channel 302 with the inlet 303 and the plurality of outlets 357a-357c.

In some embodiments, the method 900 further includes (904) controlling a flow rate of the fluidic sample (e.g., the laminar flow from the inlet 303 to toward the plurality of outlets 357a-357c) using a piezoelectric actuator (e.g., the set of piezoelectric actuators 109a-109c, the set of piezoelectric actuators 309, and/or the set of piezoelectric actuators 359a-359c) positioned at the outlet. In some embodiments, the flow rate of the fluidic sample is controlled using a piezoelectric actuator (e.g., the set of piezoelectric actuators 105 and/or the set of piezoelectric actuators 305) positioned at the inlet. For example, the set of piezoelectric actuators 305 and the set of piezoelectric actuators 359a-359c induce a laminar flow of the fluidic sample in the fluidic channel 302 from the inlet 303 toward the plurality of outlets 357a-357c.

In some embodiments, the method 900 further includes (906) dissociating components (e.g., cells, molecules, and/or other types of particles) of the fluidic sample using the piezoelectric actuator positioned upstream from a sensing zone (e.g., the sensing region 110 and/or the sensing region 310).

The method 900 further includes (908) sensing one or more properties (e.g., an impedance) of one or more particles of the fluidic sample while the one or more particles are in the sensing zone of the microfluidic channel. For example, the sensing region 310 includes a set of electrodes 325a-325b configured to sense the one or more properties of particles in the fluidic sample while the particles are in the sensing region 310.

The method 900 further includes (910) selectively manipulating, using a set of piezoelectric actuators (e.g., the set of piezoelectric actuators 121a-121b and/or the set of piezoelectric actuators 311a-311b), the one or more particles of the fluidic sample while the one or more particles are in the sensing zone. For example, the set of piezoelectric actuators 311a-311b are configured to levitate, rotate, localize, and/or deflect the particles in three dimensions while the set of electrodes 325a-325b are sensing the one or more properties of particles.

In some embodiments, the method 900 further includes (912) selectively adjusting, using the set of piezoelectric actuators, positioning of the one or more particles of the fluidic sample while the one or more particles are in the sensing zone. For example, the set of piezoelectric actuators 311a-311b are configured to change a location of the particles in the sensing region 310 (e.g., center the particles in the channel) and/or move the particles out of the sensing region 310 downstream toward the regulation region 370.

The method 900 further includes (914), after the one or more particles leave the sensing zone, ejecting the one or more particles from the microfluidic channel. In some embodiments, the third set of piezoelectric actuators and the outlet are sized to be able to eject particles with a diameter ranging from 2 μm to 50 μm. In some embodiments, the ejection of the one or more particles from the microfluidic channel is performed using the piezoelectric actuator (e.g., the set of piezoelectric actuators 109a-109c, the set of piezoelectric actuators 309, and/or the set of piezoelectric actuators 359a-359c) positioned at an outlet of the microfluidic channel.

In some embodiments, the method 900 further includes (916) deflecting the one or more particles to respective outlets of the microfluidic device according to the one or more sensed properties of each particle. For example, the set of piezoelectric actuators 371a-371b are configured to deflect the particles in the fluid sample to a specified output subregion of the output region 356 based on one or more properties of the particle in the fluid sample (e.g., each output subregion corresponding to a particular particle or a type of particle).

In light of the above disclosure, certain embodiments are described below.

(A1) In one aspect, a microfluidic device (e.g., the microfluidic device 300 and/or the microfluidic device 350) includes: (i) a microfluidic channel (e.g., the fluidic channel 302) arranged on a substrate (e.g., the substrate 159), (ii) a sensing zone (e.g., the sensing region 310) arranged along a portion of the microfluidic channel, and (iii) a set of piezoelectric actuators (e.g., the set of piezoelectric actuators 311a-311b) arranged in proximity to the sensing zone. The sensing zone is configured to measure one or more properties (e.g., impedance) of a particle (e.g., a cell) in a fluid sample in the microfluidic channel. The set of piezoelectric actuators is configured to cause manipulation of the particle (e.g., levitating, rotating, localizing, and/or deflecting the particles in three dimensions) while the particle is in the sensing zone. In some embodiments, the set of piezoelectric actuators is arranged in and/or adjacent to the sensing zone. In some embodiments, the manipulation (e.g., manipulation in three dimensions) includes rotation, levitation, localization, and/or deflection of the particle. In some embodiments, the set of piezoelectric actuators is configured for levitating, rotating, localizing, and/or deflecting the particle (e.g., deflecting to a specified downstream location of the microfluidic channel based on the one or more measured properties). In some embodiments, the sensing zone is sized such that only a single particle of the fluid sample is positioned in the sense zone at a given time (e.g., such that each particle can be sensed separately and independently). In some embodiments, the one or more properties include an impedance of the particle. In an example, the set of piezoelectric actuators is configured to cause the particle to rotate at least 90 degrees while the particle is in the sensing zone such that a three-dimensional scan of the particle is performed. For example, two piezoelectric membranes are located adjacent to and in direct contact with the sensing zone and operate at different frequencies and/or waveforms to impart rotational force to the particle. In some embodiments, the set of piezoelectric actuators are configured to hold the particle in the sensing zone and rotate it while the particle held in position (e.g., allowing for a detailed analysis of the particle at a multitude of frequencies). In some embodiments, the set of piezoelectric actuators are configured to cause a transient disruption of a laminar flow of the fluid sample through the sensing zone. In some embodiments, the set of piezoelectric actuators are configured to move the particle into a cavity (e.g., the one or more cavities 315a-315b) adjacent to the microfluidic channel and, after sensing is complete, move the particle back into the microfluidic channel.

(A2) In some embodiments of A1, the set of piezoelectric actuators are configured and operated such that a residence time of the particle in the sensing zone is longer than a time period for one full rotation of the particle. In some embodiments, the set of piezoelectric actuators are configured to cause rotation by generating acoustic waves (e.g., via oscillation) that are perpendicular to the direction of travel of the particle. In some embodiments, the set of piezoelectric actuators are configured to have an oscillation period (1/f) that is greater than the residence time of the particle in the sensing zone.

(A3) In some embodiments of A1-A2, the set of piezoelectric actuators are fluidly coupled to the microfluidic channel via one or more respective openings (e.g., the at least one cavity opening 318) for each piezoelectric actuator of the set of piezoelectric actuators. For example, piezoelectric membranes located on either side of the flow channel are connected to the microfluidic channel with the one or more respective openings which can be as large as the size of the piezoelectric membrane itself. In some embodiments, each piezoelectric actuator is fluidly coupled to the microfluidic channel via three openings (e.g., a first opening angled upstream from the piezoelectric actuator, a second opening parallel to the piezoelectric actuator, and a third opening angled downstream from the piezoelectric actuator). In some embodiments, at least a subset of the one or more respective openings are sized to be a same order of magnitude as a diameter of the particle.

(A4) In some embodiments of A1-A3, the sensing zone comprises a set of electrodes (e.g., the set of electrodes 325a-325b). The set of electrodes are configured to apply an electric field to the particle in the sensing zone. In some embodiments, the set of electrodes is continuously operating as the particle is moving through the sensing zone and is shielded from noise from the set of piezoelectric actuators (e.g., the set of piezoelectric actuators may require relatively high voltage (e.g., greater than 1 V, 10 V, 30 V, or 50 V) to drive actuation). In some embodiments, the set of electrodes are configured to provide a non-uniform electric field (e.g., not constant in a vertical direction) across the microfluidic channel.

(A5) In some embodiments of A1-A4, the set of electrodes are arranged on a first subset of sides of the microfluidic channel. The set of piezoelectric actuators are arranged on a second subset of sides of the microfluidic channel, and the first subset and the second subset have at least one shared side (e.g., the pattern 520 in FIG. 5C). In some embodiments, the set of electrodes are arranged on same sides of the microfluidic channel as the set of piezoelectric actuators. In some embodiments, the set of electrodes are arranged on different sides of the microfluidic channel as the set of piezoelectric actuators (e.g., the pattern 500 in FIG. 5B). For example, the piezoelectric actuators are positioned on lateral sides of the microfluidic channel, and the electrodes are arranged above and below the channel. In some embodiments, the set of electrodes is configured to detect data sufficient to construct a 3D electrical phenotypic image of the particle.

(A6) In some embodiments of A1-A5, the set of piezoelectric actuators comprises a first piezoelectric actuator positioned on a first side of the microfluidic device and second piezoelectric actuator positioned on a second side of the microfluidic device that is opposite of, and across the microfluidic channel from, the first side (e.g., as illustrated in FIG. 5D). In some embodiments, the set of piezoelectric actuators are coplanar with the microfluidic channel. In some embodiments, the set of piezoelectric actuators are positioned above and/or below the microfluidic channel.

(A7) In some embodiments of A1-A6, the set of piezoelectric actuators comprises three or more piezoelectric actuators. For example, the set of piezoelectric actuators comprises multiple pairs of actuators, each pair including a first actuator on one side of the microfluidic channel and a second actuator on a second side of the microfluidic channel. In some embodiments, the set of piezoelectric actuators comprises actuators on alternating sides of the microfluidic channel.

(A8) In some embodiments of A1-A7, the set of piezoelectric actuators includes a first actuator configured to operate at a first frequency and a second actuator configured to concurrently operate at a second frequency. In some embodiments, the first and second frequencies are selected to cause constructive interference at the particle (e.g., to adjust positioning of the particle) or cause destructive interference at the particle (e.g., to cause rotation of the particle). In some embodiments, a frequency of operation of the first actuator and/or the second actuator is controlled (e.g., adjusted) by control circuitry (e.g., actuation circuitry 630).

(A9) In some embodiments of A1-A8, the set of piezoelectric actuators includes a first actuator configured to selectively provide a first type of waveform (e.g., the wave 410) and a second actuator configured to concurrently provide a second type of waveform (e.g., the wave 420). For example, piezoelectric membranes are actuated with different waveforms (sinusoidal vs. sawtooth for example) to create an asymmetric drag force on the particle, thereby causing it to rotate along its travel axis.

(A10) In some embodiments of A1-A9, the set of piezoelectric actuators are further configured to adjust a position of the particle within the microfluidic channel. For example, the set of piezoelectric actuators are configured to adjust an amount of levitation and/or deflection of the particle. In some embodiments, the set of piezoelectric actuators includes a first subset of actuators configured to cause rotation of the particle and a second subset of actuators configured to adjust positioning of the particle. In some embodiments, the set of piezoelectric actuators selectively cause rotation and/or adjust position in response to respective control signals. In some embodiments, the set of piezoelectric actuators include a piezoelectric membrane located on the floor of the microfluidic channel, thereby allowing levitation of a particle as it flows through the sensing zone. In some embodiments, the set of piezoelectric actuators are configured to cause the particle to travel through the sensing zone via a Eulerian trajectory.

(A11) In some embodiments of A1-A10, the set of piezoelectric actuators comprises a first piezoelectric actuator having a first size and a first shape, and a second piezoelectric actuator having a second size and a second shape. At least one of the second size and the second shape is different than the first size and the first shape, respectively. For example, the shape of each piezoelectric actuator is rectangular, square, circular, oval, and/or annular.

(A12) In some embodiments of A1-A11, the microfluidic device further includes control circuitry coupled (e.g., actuation circuitry 630) to the set of piezoelectric actuators and configured to adjust operation of the set of piezoelectric actuators. In some embodiments, the control circuitry is also coupled to a set of electrodes (e.g., the set of electrodes 325a-325b) and configured to control operation of the set of electrodes. In some embodiments, the control circuitry adjusts operation of the set of piezoelectric actuators based on data received from the set of electrodes. In some embodiments, the control circuitry is configured to control an output of piezoelectric actuators to control sample dissociation, flow rate, sample rotation, and/or sample ejection. In some embodiments, operation of the set of piezoelectric actuators is governed by feedback from a control unit (e.g., processors 602). For example, once the particle enters the sensing zone (e.g., passes a first electrode of the set of electrodes), the control circuitry detects the particle's presence and sends signals to the piezoelectric membrane(s) in the sensing zone to start an actuation process with different waveforms (e.g., while the particle is being continuously sensed by the set of electrodes).

(A13) In some embodiments of A1-A12, a piezoelectric actuator of the set of piezoelectric actuators is configured to selectively operate in a plurality of different modes. For example, the piezoelectric actuator may be configured to selectively operate in a continuous mode, a triggered mode, a centering mode, and/or a sorting mode. For example, in the continuous mode the piezoelectric actuator is continuously operating at a frequency that is higher than the frequency of passage of the particle through the sensing zone. As another example, in the triggered mode the piezoelectric actuator operates in response to a trigger (e.g., the particle entering the sensing mode). As another example, in the centering mode the piezoelectric actuator operates to center the cell in the sensing zone (e.g., the drag forces imparted to the particle from a pair of piezoelectric actuators cancel each other and the particle is centered in the channel). As another example, in the sorting mode, the actuator operates at a higher amplitude in order to alter the trajectory of the particle, (e.g., thereby moving it to a specified output subregion of the output region 356).

(A14) In some embodiments of A1-A13, the microfluidic device further includes (i) a set of one or more inlet piezoelectric actuators (e.g., the first set of piezoelectric actuators 305) positioned at an inlet (e.g., the inlet 303) of the microfluidic channel and (ii) a set of one or more outlet piezoelectric actuators (e.g., the set of piezoelectric actuators 309 and/or the set of piezoelectric actuators 359a-359c) positioned at an outlet (e.g., the outlet 307 and/or the plurality of outlets 357a-357c) of the microfluidic channel. In some embodiments, the set of inlet piezoelectric actuators are configured to provide ultrasonication of a sample, dissociate any clogged materials, and/or prevent clogging of the inlet into the sense region. In some embodiments, the set of outlet piezoelectric actuators are configured for ejecting droplets containing particles (e.g., cells) into another system for further analysis.

(B1) In another aspect, some embodiments include a method (e.g., the method 900) performed at a microfluidic device (e.g., the microfluidic device 300 and/or the microfluidic device 350). The method comprises: (i) providing a fluidic sample comprising a plurality of particles through an inlet (e.g., the inlet 303) to a microfluidic channel (e.g., the fluidic channel 302) of the microfluidic device, (ii) sensing one or more properties (e.g., an impedance) of one or more particles of the fluidic sample while the one or more particles are in a sensing zone (e.g., the sensing region 310) of the microfluidic channel, (iii) selectively manipulating, using a set of piezoelectric actuators (e.g., the set of piezoelectric actuators 311a-311b), the one or more particles of the fluidic sample while the one or more particles are in the sensing zone, and (iv), after the one or more particles leave the sensing zone, ejecting the one or more particles from the microfluidic channel. The microfluidic channel additionally having an outlet (e.g., the outlet 307 and/or the plurality of outlets 357a-357c).

(B2) In some embodiments of B1, the method further comprises selectively adjusting, using the set of piezoelectric actuators, positioning of the one or more particles of the fluidic sample while the one or more particles are in the sensing zone.

(B3) In some embodiments of B1-B2, the method further comprises deflecting the one or more particles to respective outlets (e.g., the plurality of outlets 357a-357c) of the microfluidic device according to the one or more sensed properties of each particle.

(B4) In some embodiments of B1-B3, the method further comprises dissociating components of the fluidic sample using a piezoelectric actuator positioned upstream from the sensing zone (e.g., the set of piezoelectric actuators 305).

(B5) In some embodiments of B1-B4, the ejection of the one or more particles from the microfluidic channel is performed using a piezoelectric actuator positioned at an outlet of the microfluidic channel (e.g., the set of piezoelectric actuators 309 and/or the set of piezoelectric actuators 359a-359c).

(B6) In some embodiments of B1-B5, the method further comprises controlling a flow rate of the fluidic sample using the piezoelectric actuator positioned at the outlet.

(B7) In some embodiments of B1-B6, the piezoelectric actuator positioned at the outlet and/or the piezoelectric actuator positioned upstream from the sensing zone are operated so as to cause a laminar flow through the sensing zone.

It will be understood that, although the terms first, second, etc. may be used herein to describe various elements, these elements should not be limited by these terms. These terms are only used to distinguish one element from another. For example, a first array could be termed a second array, and, similarly, a second array could be termed a first array, without departing from the scope of the various described embodiments. The first array and the second array are both arrays, but they are not the same array.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A microfluidic device, comprising:
a microfluidic channel arranged on a substrate;
a sensing zone arranged along a portion of the microfluidic channel, the sensing zone configured to measure one or more properties of a particle in a fluid sample in the microfluidic channel;
a set of piezoelectric actuators arranged in proximity to the sensing zone, the set of piezoelectric actuators configured to cause manipulation of the particle while the particle is in the sensing zone.

2. The microfluidic device of claim 1, wherein the set of piezoelectric actuators are configured and operated such that a residence time of the particle in the sensing zone is longer than a time period for one full rotation of the particle.

3. The microfluidic device of claim 1, wherein the set of piezoelectric actuators are fluidly coupled to the microfluidic channel via one or more respective openings for each piezoelectric actuator of the set of piezoelectric actuators.

4. The microfluidic device of claim 1, wherein the sensing zone comprises a set of electrodes, wherein the set of electrodes are configured to apply an electric field to the particle in the sensing zone.

5. The microfluidic device of claim 4, wherein the set of electrodes are arranged on a first subset of the sides of the microfluidic channel, wherein the set of piezoelectric actuators are arranged on a second subset of the sides of the microfluidic channel, and wherein the first subset and the second subset have at least shared side.

6. The microfluidic device of claim 1, wherein the set of piezoelectric actuators comprises a first piezoelectric actuator positioned on a first side of the microfluidic device and second piezoelectric actuator positioned on a second side of the microfluidic device that is opposite of, and across the microfluidic channel from, the first side.

7. The microfluidic device of claim 1, wherein the set of piezoelectric actuators comprises three or more piezoelectric actuators.

8. The microfluidic device of claim 1, wherein the set of piezoelectric actuators includes a first actuator configured to operate at a first frequency and a second actuator configured to concurrently operate at a second frequency.

9. The microfluidic device of claim 1, wherein the set of piezoelectric actuators includes a first actuator configured to selectively provide a first type of waveform and a second actuator configured to concurrently provide a second type of waveform.

10. The microfluidic device of claim 1, wherein the set of piezoelectric actuators are further configured to adjust a position of the particle within the microfluidic channel.

11. The microfluidic device of claim 1, wherein the set of piezoelectric actuators comprises a first piezoelectric actuator having a first size and a first shape, and a second piezoelectric actuator having a second size and a second shape, wherein the at least one of the second size and the second shape is different than the first size and the first shape.

12. The microfluidic device of claim 1, further comprising control circuitry coupled to the set of piezoelectric actuators and configured to adjust operation of the set of piezoelectric actuators.

13. The microfluidic device of claim 1, wherein an actuator of the set of piezoelectric actuators is configured to selectively operate in a plurality of different modes.

14. The microfluidic device of claim 1, further comprising:
a set of one or more inlet piezoelectric actuators positioned at an inlet of the microfluidic channel; and
a set of one or more outlet piezoelectric actuators positioned at an outlet of the microfluidic channel.

15. A method performed at a microfluidic device, the method comprising:
providing a fluidic sample comprising plurality of particles through an inlet to a microfluidic channel of the microfluidic device, the microfluidic channel having an outlet;
sensing one or more properties of one or more particles of the fluidic sample while the one or more particles are in a sensing zone of the microfluidic channel;
selectively manipulating, using a set of piezoelectric actuators, the one or more particles of the fluidic sample while the one or more particles are in the sensing zone; and
after the one or more particles leave the sensing zone, ejecting the one or more particles from the microfluidic channel.

16. The method of claim 15, further comprising selectively adjusting, using the set of piezoelectric actuators, positioning of the one or more particles of the fluidic sample while the one or more particles are in the sensing zone.

17. The method of claim 15, further comprising deflecting the one or more particles to respective outlets of the microfluidic device according to the one or more sensed properties of each particle.

18. The method of claim 15, further comprising dissociating components of the fluidic sample using a piezoelectric actuator positioned upstream from the sensing zone.

19. The method of claim 15, wherein the ejection of the one or more particles from the microfluidic channel is performed using a piezoelectric actuator positioned at the outlet of the microfluidic channel.

20. The method of claim 19, further comprising controlling a flow rate of the fluidic sample using the piezoelectric actuator positioned at the outlet.
